(19) United States
(12) Patent Application Publication
(10) Pub. No.: US 2014/0184592 A1
(43) Pub. Date: Jul. 3, 2014

(54) CREATING, EDITING, AND QUERYING PARAMETRIC MODELS, E.G., USING NESTED BOUNDING VOLUMES

(71) Applicant: KETCH TECHNOLOGY, LLC, Seattle, WA (US)

(72) Inventor: Daniel Belcher, Seattle, WA (US)

(21) Appl. No.: 13/839,853

(22) Filed: Mar. 15, 2013

Related U.S. Application Data
(60) Provisional application No. 61/747,863, filed on Dec. 31, 2012.

(51) Int. Cl. G06T 17/00

(52) U.S. Cl. CPC G06T 17/00
USPC 345/420

(57) ABSTRACT

Technology is disclosed for parametric configuration of an object. The technology brings the visual programming interaction paradigm to the same three-dimensional space occupied by the object itself. A user interface maps parameters that govern an object as interactive control-points on a translucent three-dimensional bounding volume rendered around the object. The user interacts with this interface and the parameters within and on the surface of the bounding volume. Parametric connections between objects are made by links from one bounding volume to another, or from one parameter to another within the same object. The object may contain many child-objects, each represented as a nested bounding volume within the volume of the parent object.

### CROSS-REFERENCE TO RELATED APPLICATION

This patent application claims the benefit of commonly assigned U.S. Provisional Patent Application Ser. No. 61/747,863, entitled “CREATING, EDITING, AND QUERYING PARAMETRIC MODELS, E. G., USING NESTED BOUNDING VOLUMES” and filed on Dec. 31, 2012, which is incorporated herein in its entirety by reference.

### BACKGROUND

The following relates to computational three-dimensional models, and more specifically, to models and objects governed by parametric relationships.

Computer-aided design, drafting, and modeling have been some of the most important applications utilizing computers since their inception. The early computer-aided design applications were used to simplify the creation of two-dimensional models of design objects. The creation of architectural drawings and electronic circuit layouts were just a few of these early applications. The benefits realized by two-dimensional computer drafting applications are significantly multiplied when such an application adds the capability to model geometries in three dimensions. FIG. 1 illustrates a typical three-dimensional modeling environment. The majority of such modeling applications utilize a library 104 of geometric primitives and modifier tools 110 to manipulate geometry 100. The user draws lines, arcs, and other geometric shapes 108 with specific dimensions 106, positions, and orientations in a three-dimensional Cartesian space 102. Modifier tools 110, such as move, rotate, and scale, are used to make changes to attributes of the modeled objects. To those skilled in the art, this is frequently referred to as manual or direct modeling.

A subset of three-dimensional modeling applications allows associative parametric relationships to define the model. The benefits realized by three-dimensional computer modeling are again significantly multiplied when such an application adds the ability to generate and regenerate a design based upon different parameters. FIG. 2 illustrates a simplified parametric modeling environment. In such applications, the user selects certain geometric primitives 200 from a library 202 and adds them to a modeling coordinate system that is viewed through a perspective or orthographic view 204. In contrast with non-parametric environments, associative parametric applications enable the user to define certain object properties 206 as variables or parameters that relate to other properties 210. Rules that govern these relationships are thus defined within a separate window or menu 208. Changes made to one property are then applied within a computational rule-based system (often invisible to the user) that effect changes to the form of the model. A major advantage of parametric modeling processes is their capacity to rapidly regenerate the model based upon the different initial values. It is generally accepted that parametric methods dramatically speed up the process of making changes to a model, as well as allowing the user greater agency with regard to “what if” types of modification. Parametric modeling is associated with complex objects because it enables greater control and accuracy over the geometry and associated data governed by the model. The user focuses on modeling relationships and constraints of an abstract system, rather than on static geometric form.

FIG. 2 represents parametric modeling in a very simplified form. Over the years, many approaches to parametric modeling have been embodied in various design software applications that build upon the basic framework depicted in FIG. 2. A set of common methods of parametric representation and manipulation has developed, which can be further categorized thus:
Script-based parametric modeling (FIG. 3)
Tree-based parametric modeling (FIG. 4)
Parameter table enabled modeling (FIG. 5)
Visual programming-based parametric modeling (FIG. 6)

Each of these approaches to parametric modeling are considered in turn.

### Script-Based

For many years, numerous computer-aided design applications have included script-based control of geometry using various programming languages. FIG. 3 depicts an abstract script-based approach to parametric modeling. Typically, the user writes out programs 300 in a text-editing window 302, using a predefined syntax, and then compiles 304 and runs 306 the program. Once all steps in the script have executed, the user can view the results 308 in a perspective viewport window 310.

Despite a two-decade history, script-based modeling has not received widespread adoption across the user community of computer-aided design. With the exception of engineering, computer programming is rarely part of the educational curriculum of disciplines such as architecture, industrial, jewelry, or marine design. Computer programming has a difficult learning curve and requires a significant investment of time and energy. As a result, scripting has been used exclusively by expert user groups and those with previous training and experience with programming. When using script-based approaches to 3D modeling, both the spatial and linguistic cognitive systems are active simultaneously, increasing the cognitive load on the designer. The designer, or modeler, is forced to simulate the effects of a change in the text-based algorithm in their mind, then compile and run the code to observe the results. Furthermore, due to the strict nature of program compilers, small syntax errors, such as a missing semicolon, can cause the novice to abandon scripting efforts before they bear fruit.

### Tree-Based

Another common representation and interaction paradigm within parametric modeling is the use of interactive tree structures. Tree-based parametric modeling does not require any knowledge of computer programming. The act of navigating a hierarchical tree is a simple, familiar interaction often experienced when navigating a computer file system. FIG. 4 shows a simplified version of a hierarchical tree-based parametric modeling environment. As with nearly all three-dimensional modeling environments, the user views the resulting geometry 400 through an orthographic or perspectival viewing window 402. In all tree-based embodiments, the user navigates a tree, expanding or collapsing parent and children nodes, moving one parametric value from one branch to another as desired. In some implementations, a tree view 404 is shown in a separate window, much like a hierarchical file-system browser where folders and files are shown as nested branches that can be expanded or collapsed by the user. In this parametric modeling paradigm, the branches of the tree represent geometric objects and their associated data. Parent objects 406 have children objects 408 containing sub-branches with parametric values 410. In some embodiments, this tree view is rendered as a two dimensional head's up display (HUD) superimposed on the three-dimensional viewing window 402 itself.

Tree-based approaches lack multiple data inheritance and parent-child relationships are rigid. This is similar to the requirement that, in a computer file system, a given file is contained in a single folder or directory. As with file-system tree browsers, this approach frequently necessitates “short-cut” proxy objects that link to other branches in the tree. The strict hierarchical branching nature of the tree becomes one of the major limitations in models where branches of one trunk need to be connected to child branches of another distal branch. Another disadvantage is that such trees are predominantly text-based. While navigating the tree, the user reads the object and parameter names, relying on the branching nature of the tree to infer spatial relationships. Furthermore, trees are frequently rendered in a separate window, sacrificing screen area that could be devoted to the model itself.

### Parameter Table Enabled Modeling

Various associative parametric modeling applications leverage text-based tables of design parameters that resemble a spreadsheet. This method is sometimes called a parameter table or design table based approach. The advantage of such an approach is that finding and editing values in a spreadsheet is an interaction that many users are familiar with. FIG. 5 depicts a typical parameter table-based parametric modeling environment. Much like other approaches, the resulting geometric model 500 is rendered in its own view 502. The user opens the list of parametric values in a separate view 504, finds a relevant parameter 506, and manually changes a value 508. A parameter such as a dimensional value 508 is listed as a row within the spreadsheet. When necessary, a formula 510 that modifies the parametric value is expressed directly in the table, however, this is often expressed in a separate cell from the parameter it modifies, using a look-up code such as a cell row or column index value 512.

The major disadvantage of design tables is that the process of generating the resulting model is implicit in the linking between formulas and table values. This disadvantage is common to all spreadsheet-like methods: the data is exposed and explicit, whereas the algorithms and formulas that govern the relationships are implicit and/or hidden. Even with models of modest complexity, this disadvantage leads to situations where modifying the value of one parameter in a design table may lead to changes in the model that are not foreseen and difficult to find. The nature of design tables limits their usefulness to the later phases of the design in which parametric relationships are highly stable and only the parameter values need modification.

### Visual Programming

Visual programming paradigms enable users to create computer programs by manipulating graphical elements rather than by entering text. In recent years, visual programming software has increased the ease and popularity of parametric modeling. Source-sink node-based systems that employ visual data flow modeling have garnered a vibrant and dedicated user-community within the architectural and industrial design industries. The locus of interaction in such software applications is the parametric graph itself, a dynamic representation comprised of nodes 600 and linking arcs 602 in a network akin to an electronic wiring diagram. The user adds node types 604 from a library 606 to a two-dimensional canvas 608 in a separate view from the rendered geometric object 612. The nodes encapsulate internal values 614 or functions. In many embodiments, the input and output parameters 616 of the nodes are exposed near the boundaries of the node. Users drag links 602 between the parameters of nodes to send parametric data between the different nodes in the graph.

One of the advantages of node-based systems over previous tree-based or design table-based approaches is that they render explicit the entire history of the design. When changing a source-node parameter value, it is easy to trace the path of data as it propagates through the graph to the sink node. Another advantage is that little knowledge of computer programming is necessary to begin using such visual programming methods. Additionally, the user of such applications can leverage spatial memory as well as explicit spatial organization strategies to cluster related nodes in the various areas of the graph in the two-dimensional canvas.

One of the disadvantages of current visual programming approaches is that the user is required to learn to recognize, navigate, and manipulate nodes, parameters, and their links in an intermediate window or canvas separate from the geometric model itself. This approach forces the user to maintain a spatial memory for two divergent Cartesian spaces: one for the two-dimensional canvas space of the parametric graph and one for the three-dimensional space of the resulting geometric model. Interactions between the two Cartesian spaces are unidirectional or limited to selection of the object. This indirect approach effectively shifts the work of modeling from the three-dimensional Cartesian space to the two-dimensional Cartesian space of the canvas 608. This increases the cognitive burden on the user. As a result, normally quick and straightforward changes to such a model require an understanding of the underlying graph representation. Furthermore, in the case of complex graphs or designs with multiple authors, this requires significant commenting and organization effort to maintain a robust and legible graph. It is often difficult for a user unfamiliar with the parametric model to query an object in the resulting model and see how the parameters govern its form. Instead, those unfamiliar with the graph, or even those who created the graph but have not recently interacted with it, need to trace or retrace the data through the graph or employ a process of “flexing” parameters to see the result of the changes.

Another additional disadvantage of canvas based visual programming paradigms is that the intermediate representation of the canvas requires increased screen space devoted to rendering the canvas, often occluding the view of the geometric object itself.

### Parametric Modeling

Computer applications that provide parametric modeling capabilities have been complex and required significant user training. It is common knowledge within the industry that parametric modeling is difficult to learn because it requires a manner of thinking that is not commonly a part of educational curriculum. One barrier to adoption of parametric modeling is that those users who are new to the methods and thought processes are required to learn to manipulate an intermediate representation or adopt a metaphor that is often foreign to them. One of the major challenges of learning to model parametrically is learning to think differently about form. This is akin to learning to think like a computer programmer, where variables and algorithms govern the current state of the design rather than static, user-defined statements. This initial hurdle is difficult to overcome, as it necessitates a radical departure from the object rendered onscreen in favor of a dynamic representation in a separate view. However, recent popularity of visual programming and data flow approaches has demonstrated that leveraging human spatial reasoning capabilities facilitates adoption of parametric approaches in diverse user groups.

### BRIEF DESCRIPTION OF THE DRAWINGS

FIG. 1 illustrates a typical 3D modeling environment.

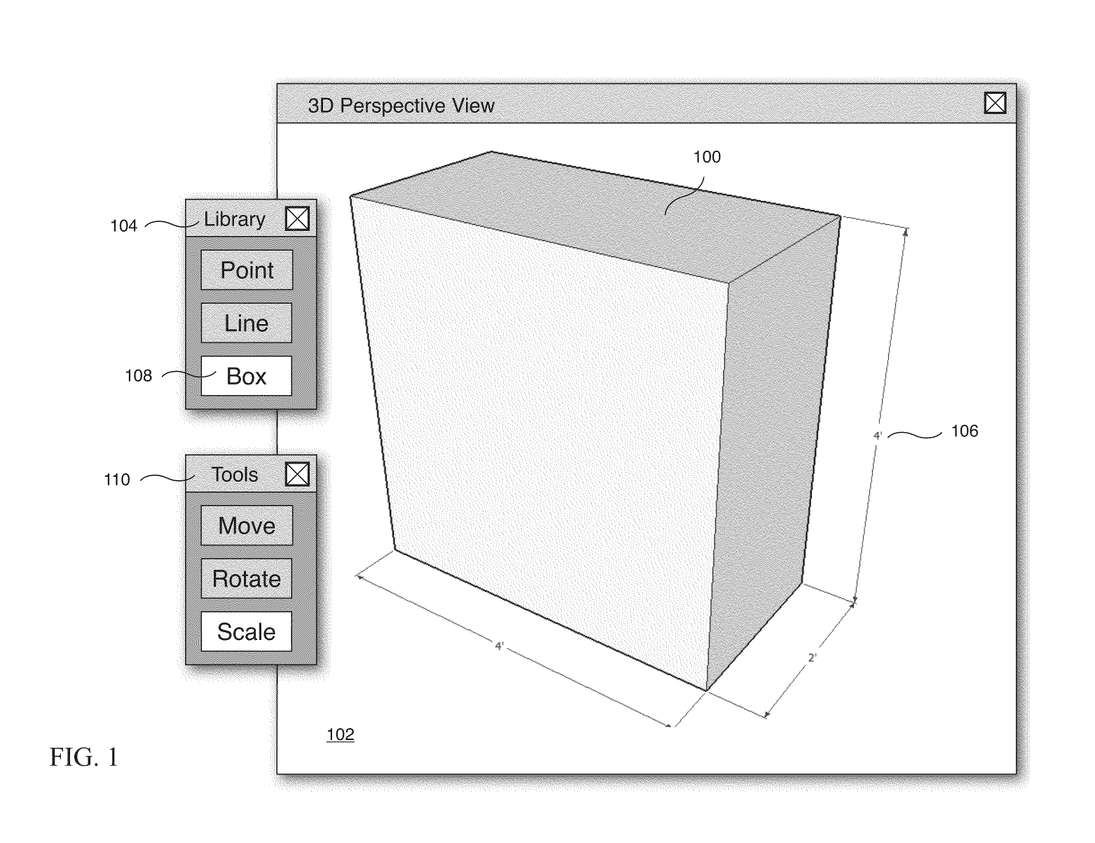

FIG. 2 illustrates a simplified parametric modeling environment.

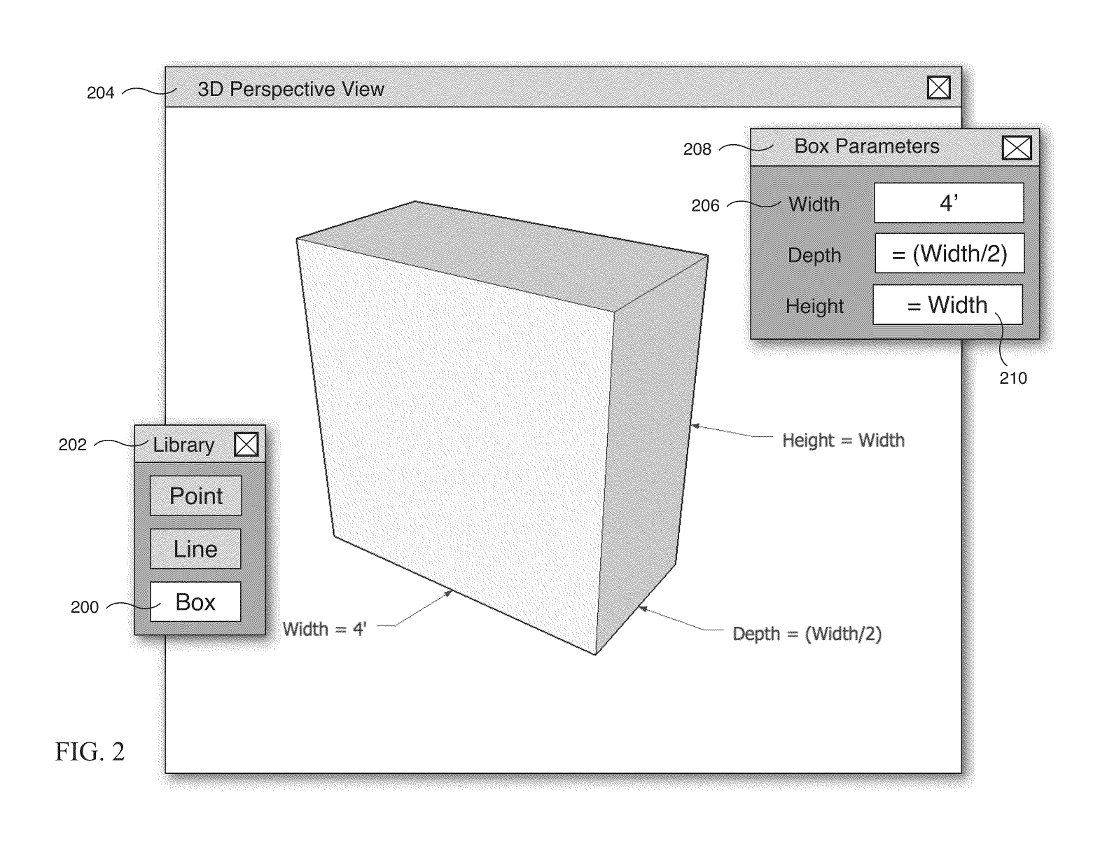

FIG. 3 illustrates a simplified script-based parametric modeling application.

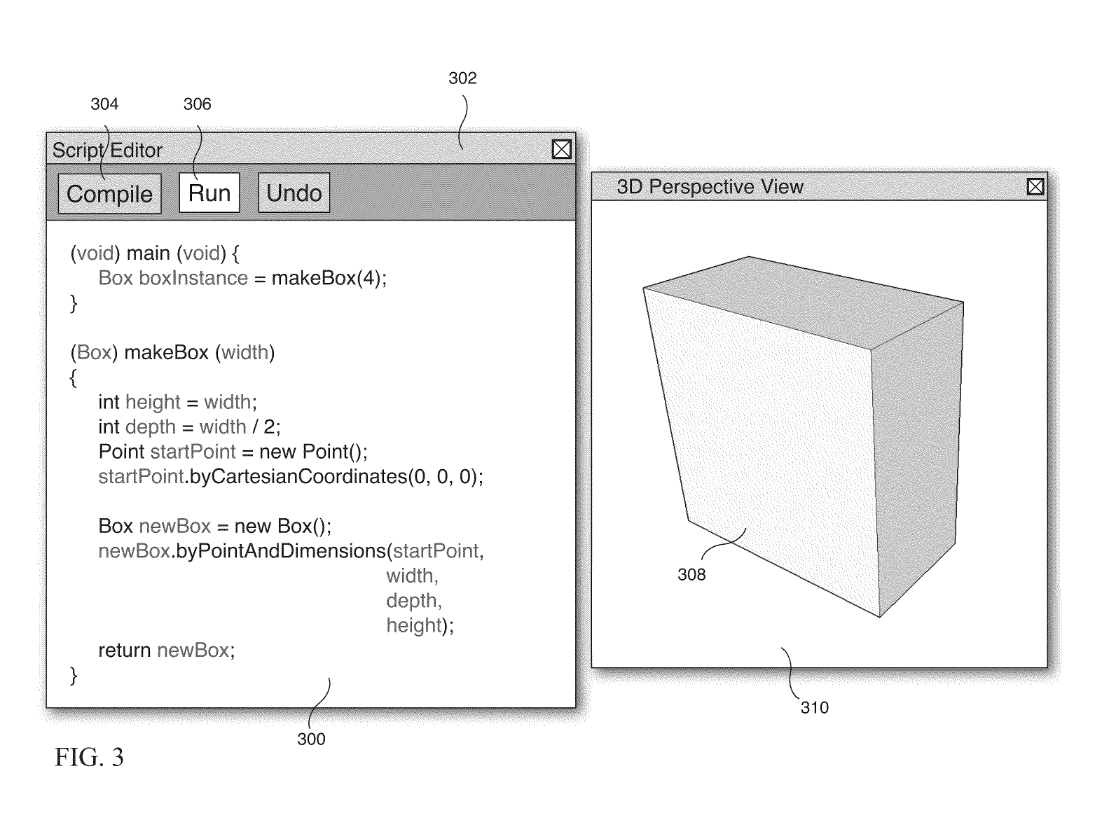

FIG. 4 illustrates a simplified tree-based parametric modeling application.

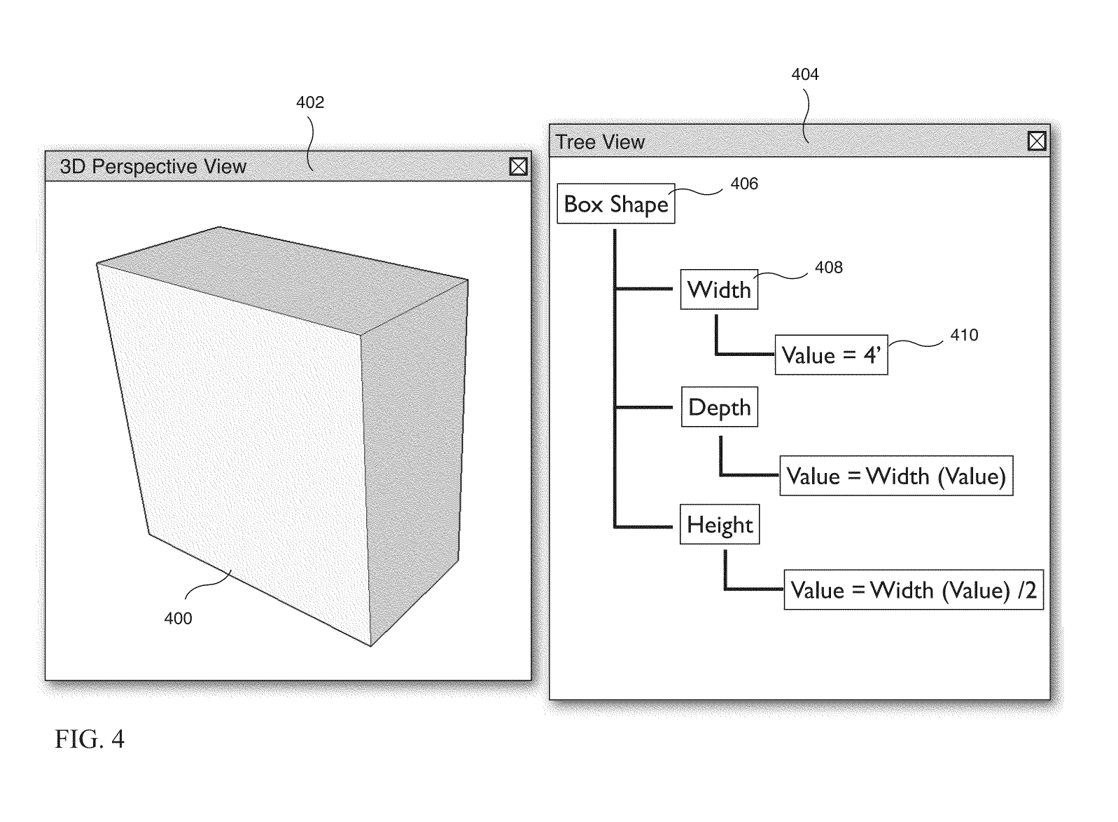

FIG. 5 illustrates a typical parametric table modeling application.

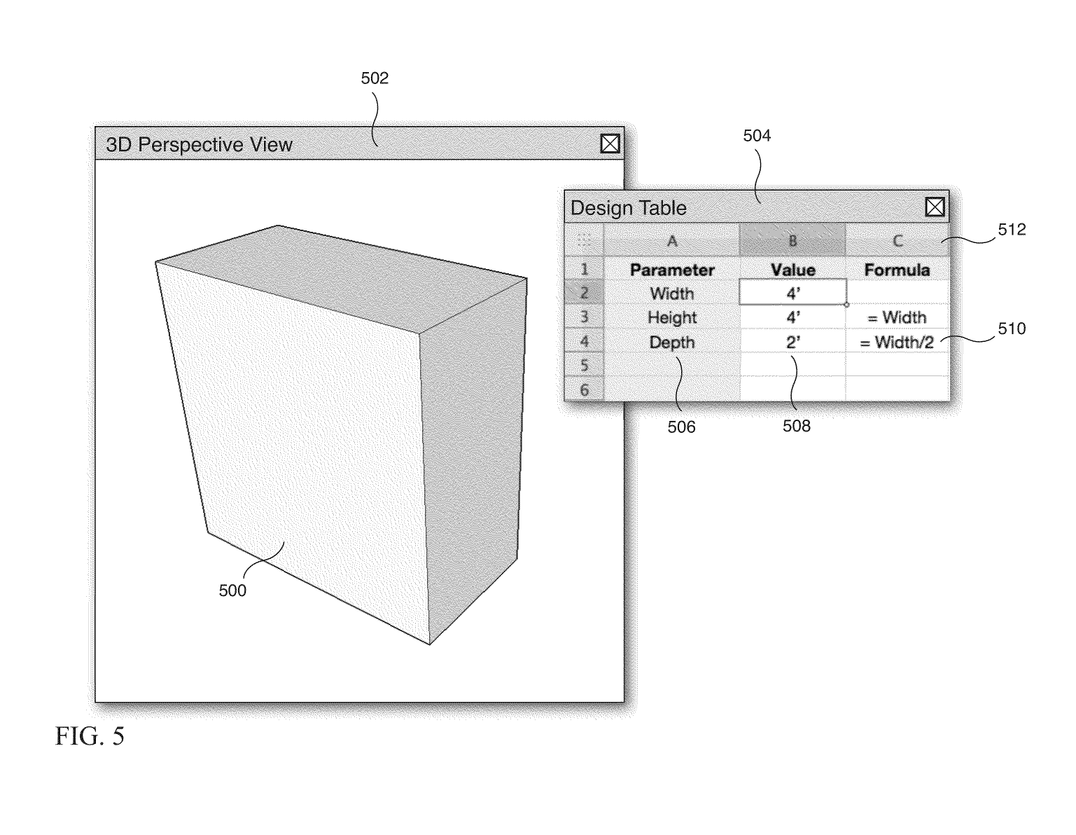

FIG. 6 illustrates a visual programming, node-link based parametric modeling application.

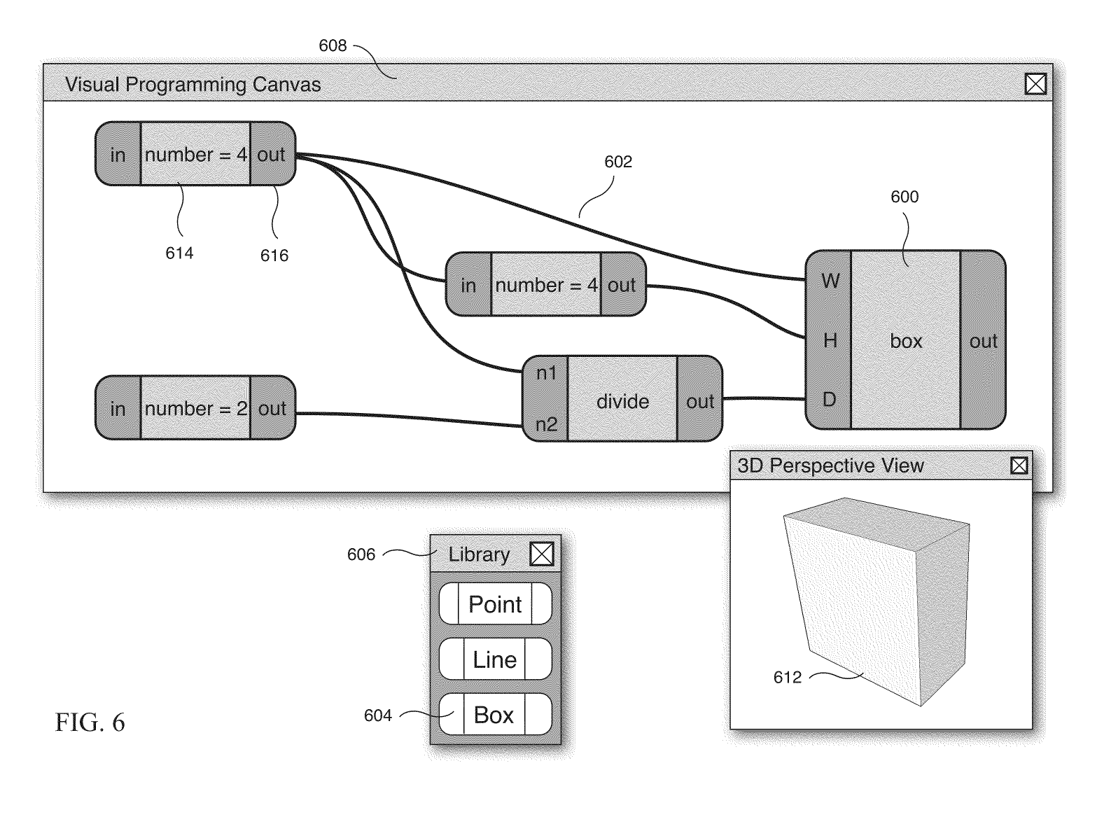

FIG. 7 illustrates the interface of a single object such as a vector.

FIG. 8 illustrates the software architecture of an embodiment.

FIG. 9 illustrates the object data architecture of the model.

FIG. 10 illustrates the object data architecture of the user interface controller.

FIG. 11 is a block diagram that illustrates a computer system.

FIG. 12 illustrates a user adding an object to the root Cartesian space from a library.

FIG. 13 illustrates the display after the user selects an object.

FIG. 14 illustrates the rendered bounding volume that exposes the object's interface.

FIG. 15 illustrates the user rotating the bounding volume.

FIG. 16 illustrates the displayed pop-over window when the user queries a parameter.

FIG. 17 illustrates the user closing the object's interface.

FIG. 18 illustrates the user adding an additional object from the library.

FIG. 19 illustrates the user selecting the line object.

FIG. 20 illustates the rendered bounding volume that exposes the object's interface.

FIG. 21 illustrates the user querying an input parameter of the object.

FIG. 22 illustrates the user querying an input parameter of the object.

FIG. 23 illustrates the user querying an input parameter of the object.

FIG. 24 illustrates the user selecting the point object.

FIG. 25 illustrates the user exposing the bounding volume of the object's interface.

FIG. 26 illustrates the user rotating the bounding volume to show output parameters.

FIG. 27 illustrates the user querying the output parameter of the object.

FIG. 28 illustrates the user dragging a wire connection from an output to an input.

FIG. 29 illustrates the bounding geometry rotating and type checking on the inputs.

FIG. 30 illustrates the rendering of the parametric link connection using a wire.

FIG. 31 illustrates the resulting geometry as the parametric graph is updated.

FIG. 32 illustrates the resulting geometry when the object interface is not exposed.

FIG. 33 illustrates how the two objects are two separate instances.

FIG. 34 illustrates the result of exposing the point interface.

FIG. 35 illustrates the result of hiding the point interface.

FIG. 36 illustrates the user creating a new object.

FIG. 37 illustrates the user entering into the bounding volume of the new object.

FIG. 38 illustrates the user exposing the point object's interface.

FIG. 39 illustrates the user exposing the line object's interface.

FIG. 40 illustrates the result of the user adding an input parameter to the parent object.

FIG. 41 illustrates the result of the user adding an input parameter to the parent object.

FIG. 42 illustrates the result of deleting the point object.

FIG. 43 illustrates the user adding a Z unit vector to the parent object from the library.

FIG. 44 illustrates the user exposing the interface of the unit vector.

FIG. 45 illustrates the user linking the unit vector to the line direction parameter.

FIG. 46 illustrates the result of hiding the Z unit vector's interface.

FIG. 47 illustrates the user rotating the interface of the line object to view the outputs.

FIG. 48 illustrates the result of the user adding an output parameter to the parent object.

FIG. 49 illustrates the result of the user renaming the object's class and instance name.

FIG. 50 illustrates the result of closing the implementation of new line object.

### DETAILED DESCRIPTION

The methods listed above in the Background section abstract and organize parameters in a way that use intermediate representations that are disconnected spatially from the model they comprise. The technology disclosed herein, method, and user interface improves on previous parametric modeling approaches by mapping the visual programming interaction paradigm to the same three-dimensional Cartesian space occupied by the geometric model itself, eliminating the need for an intermediate representation. This reduces the cognitive load on the user by inscribing the parametric relationships within the same three-dimensional space as the object. Additionally, this approach provides users with a more direct connection to the object they are manipulating and reduces the screen real-estate devoted to the parametric graph. This approach brings many of the advantages of object-oriented programming and data flow modeling to a model-centric parametric environment.

The inventor is unaware of any formerly developed parametric modeling software that provides the user with direct access to the parameters that govern the design object organized in three-dimensional space surrounding the object itself.

Technology is thus disclosed for parametric modeling of parameters that govern the object as interactive control-points on a translucent three-dimensional bounding volume rendered around the object. The user interacts with this bounding volume and the parameters contained within and on the surface of the bounding volume. Parametric connections between objects are made by establishing links from one bounding volume to another, or from one parameter to another parameter within the same bounding volume. The bounding volume thus constitutes the object's interface. The implementation of the object is contained within the bounding volume. The object may contain many child-objects, each represented as a nested bounding volume within the bounding volume of the parent object, much like the popular folk toy known as the “Russian Doll.” Hence, the nodes in the parametric graph are mapped around the objects themselves within the same three-dimensional space as the model itself. Data sent between objects are represented as links drawn between parameters on the surface of the bounding volume. These relationships can be hidden by the user or rendered explicitly on screen. When viewing compound objects containing one or more child objects, exploded views of the objects are used to separate and delineate one object from another. The user can create new parametric objects by linking and nesting objects into bounding volume clusters. From within each cluster, the user can assign objects as input parameters or output parameters by moving them into the input or output layer zones respectively. The user can trace the flow of parametric data through the model by following the arcs representing links from one bounding volume to another. In this fashion, the representation of the parametric definition and the resulting geometry, with its associated data, are collocated with each other in the same Cartesian space. This allows for a natural grouping of parameters with objects, without sacrificing the ability to link distal objects and their associated data.

Several embodiments of the described technology are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can comprise computer-readable storage media (e.g., “non-transitory” media) and computer-readable transmission media.

Those skilled in the art will appreciate that the logic illustrated in flow diagrams and described herein may be altered in a variety of ways. For example, the order of the logic may be rearranged, substeps may be performed in parallel, illustrated logic may be omitted, other logic may be included, etc. Moreover, whereas table diagrams may illustrate tables whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; etc.

A glossary of terms may be useful for the reader.

Abstraction: A process by which programs and data are defined with a representation similar in form to its meaning, while hiding the implementation details.

Acyclic (Graph): A graph or process without direct cycles. In other words: a graph containing no loops.

Augmented Reality (AR): AR is a live, direct or indirect, view of a physical, real-world environment whose elements are augmented by computer-generated sensory input such as sound, video, graphics or GPS data.

Bounding Volume: In computer graphics and computational geometry, a bounding volume for a set of objects is a closed volume that completely contains the union of the objects in the set. Normally, bounding volumes are used to improve the efficiency of geometrical operations by using simple volumes to contain more complex objects because such volumes have more efficient ways to test for intersection.

Canvas: The two dimensional drawing area where nodes are placed and connections are made.

Class: A template for an instance of an object. For example, the class Dog would represent the properties and functionality of dogs in general. A single instance of dog would be an instance of the Dog class.

Coordinate: A point in Cartesian space usually represented by an ordered x, y, z triplet.

Control: A user interface element that responds to user interaction, such as a button, screen area, or slider.

Controller: In Model-View-Controller (MVC) terminology, a controller (or controllers) structures and mediates between the model and the views.

Cognitive load: A term often used in cognitive science to illustrate the load on human working memory during complex learning activities when the amount of information or interactions that must be processed can either under-load or over-load the finite amount of working memory an individual possesses.

Encapsulation: A programming mechanism that facilitates the bundling and hiding of data with the methods operating on that data.

Graph: An mathematical representation of a set of vertices connected by edges. In this context, vertices are objects represented as nodes and edges are referred to as links.

History: A record of the discrete steps performed to construct a model or a sub-set of a model.

Inheritance: A mechanism for reusing properties, methods, and data from an existing object. In the example of a Cat class, a single instance of cat would be an instance of the Cat class. Changes to the Cat class are inherited by all instances of Cat.

Implementation: The internal workings of an object, here referring to all internal child objects contained within the bounding volume of a parent object or within the graph of a parent node. In computer programming languages, such as C++, the implementation is contained within a separate file with the extension “.cpp.”

Instance: An occurrence of a class or copy of an object.

Interface: Here used in two different ways: 1) the properties and methods exposed on the bounding volume of an object that compose the parameters of the object, hereafter referred to as “interface.” In computer programming languages, such as C++, the interface of an object is contained within a separate header file with the extension “.h.” Or 2) User Interface, as in the views, controls, graphics, and feedback that are presented to the user allowing them to interact with the computer program, hereafter referred to as “user interface.”

Library: A collection of classes organized in a hierarchical fashion.

Link: A connection made between two nodes in a graph to represent connectedness. A link can be thought of as a conduit for sending data between one object and another.

Method: A procedure, function, or action associated with a class. In the example of a Dog class, there might be methods called bark, run, or sit.

Model: (1) A computational representation of a real-world object. As in “3D model.” (2) In Model-View-Controller (MVC) terminology: the data and business logic of the application.

Model-View-Controller (MVC): A software architecture design pattern that separates the representation of information from the user's interaction with it. The model consists of application data and business rules; and the controller mediates input, converting it to commands for the model or view, which the user sees.

Node: A representation of an object in a graph.

Normal: A line or a unit vector perpendicular to a surface used to represent the direction the surface is facing. In computer graphics, it is often necessary to render only a single face of a polygon. A normal is used to determine which face should be rendered.

Object: An instance of a class.

Object-Oriented: A paradigm of representing things as objects that inherit from template classes consisting of properties, data, and methods associated with the class.

Origin: A point in a coordinate space used as a reference point for the geometry of the surrounding space.

Parameter: A property of an object that is used as an input or output of that object.

Polymorphism: The ability to create an object that has more than one form or behavior. Polymorphism is most often achieved by over-riding methods of an object. For example if there are two instances of the class Dog, each has the method bark. However, by implementing bark differently in each respective instance (or over-riding), each instance of class Dog can bark differently.

Property: Data associated with an object that is shared as part of the interface of an object. Properties that are part of the interface either input or output parameters of the object. Properties that are part of the implementation of an object are not accessible to other objects.

Shader: A computer program that is primarily used to calculate rendering effects on graphics hardware with a high degree of flexibility and speed.

Slider: A user interface widget control that represents a range of values that can be selected by moving a point along an axis.

Sprite: In computer graphics, a sprite (also known as an impostor, billboard, etc.) is a two-dimensional image or animation that is integrated into a larger scene.

Topological Sort: An ordering of nodes in a directed graph that is a linear order that represents a valid sequence of nodes. For example, in a simple directed graph with three nodes n1, n2 and n3, and two links n2: n1 and n2: n3, a topological sort assures a sequence in which n2 is always before n1 and n3.

Vector: A geometric entity that defines a magnitude and a direction. A unit vector is a vector in a normalized vector space whose length is 1.

View: In Model-View-Controller terminology, a view can be any output representation of data, such as a chart or a diagram. Multiple views of the same data are possible, such as a pie chart for management and a tabular view for accountants.

Widget: A type of pseudo-node that does not represent an object, but rather a control that is used to send data to other nodes within the graph. An example of a widget is a slider.

### 1.User Interface Overview

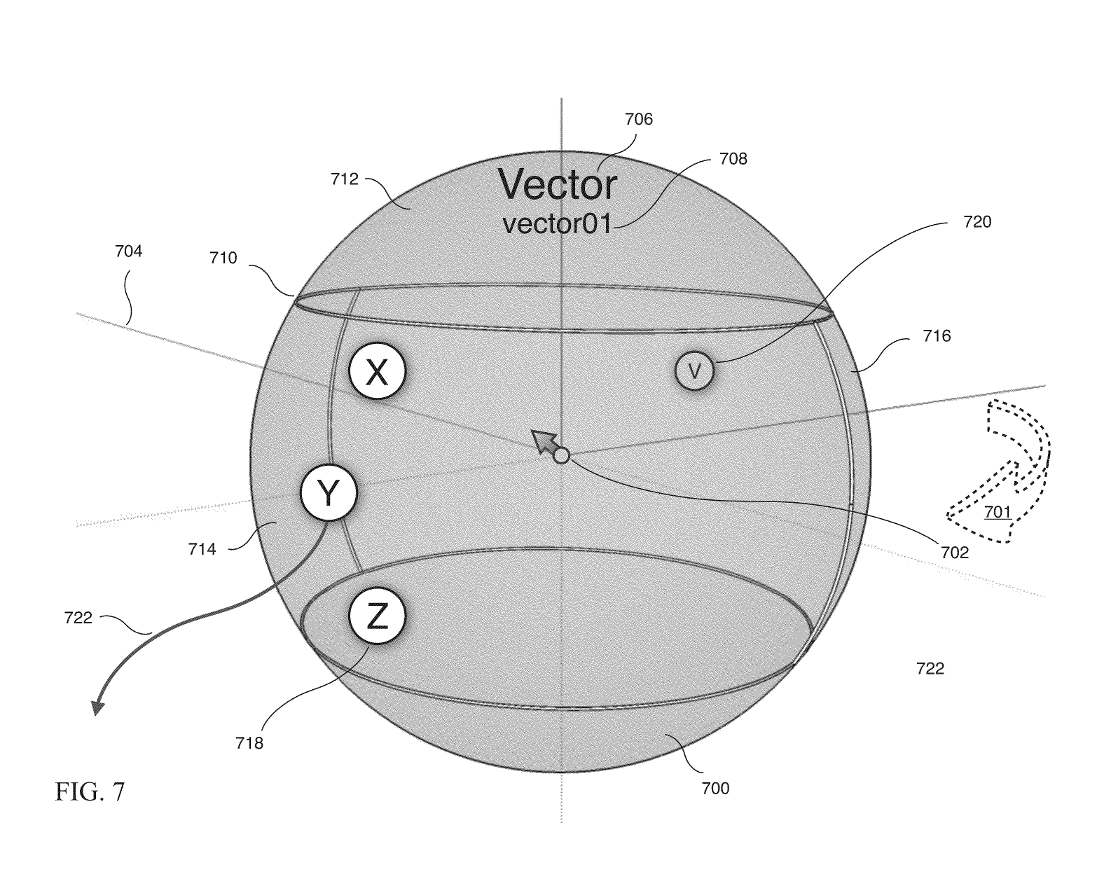

FIG. 7 illustrates an interface of a simple Cartesian vector object 702. A bounding volume is rendered. The term “bounding volume” is hereafter used synonymously when referring to an object's “interface.” A bounding volume 700 around the object delineates the object within a root Cartesian space 704 here represented by axes. An object's internal implementation is hidden within the bounding volume 700.

A class name 706 of the object is rendered onscreen on the surface of the bounding volume 700. An instance name 708 of the object is rendered onscreen on the surface of the bounding volume 700.

In some embodiments, the bounding volume 700 is divided into different zones. Curves or lines 710 are drawn on the surface of the bounding volume 700. In the embodiment shown in FIG. 7, the bounding volume 700 is divided into zones for identity 712, for input parameters 714, and for output parameters 716.

The input and output parameters are rendered on the surface of the bounding volume 700 within an input zone 714 and an output zone 716 respectively. In the present vector object example, a Z input parameter 718 is shown below the X and Y input parameters. Connecting data links into this parameter 718 can result in changes to the vector object's Z magnitude and direction in a Cartesian space 704. A V output parameter 720 is rendered on the surface of the bounding geometry 700 within the output zone 716. In this example, the V output parameter returns the entire vector object 702 and all of its parameters.

The bounding volume 700 may be rotated 701 by a user using the user interface independently of the rendered object 702 contained within the bounding volume.

Data is sent between parameters through links 722 established by the user.

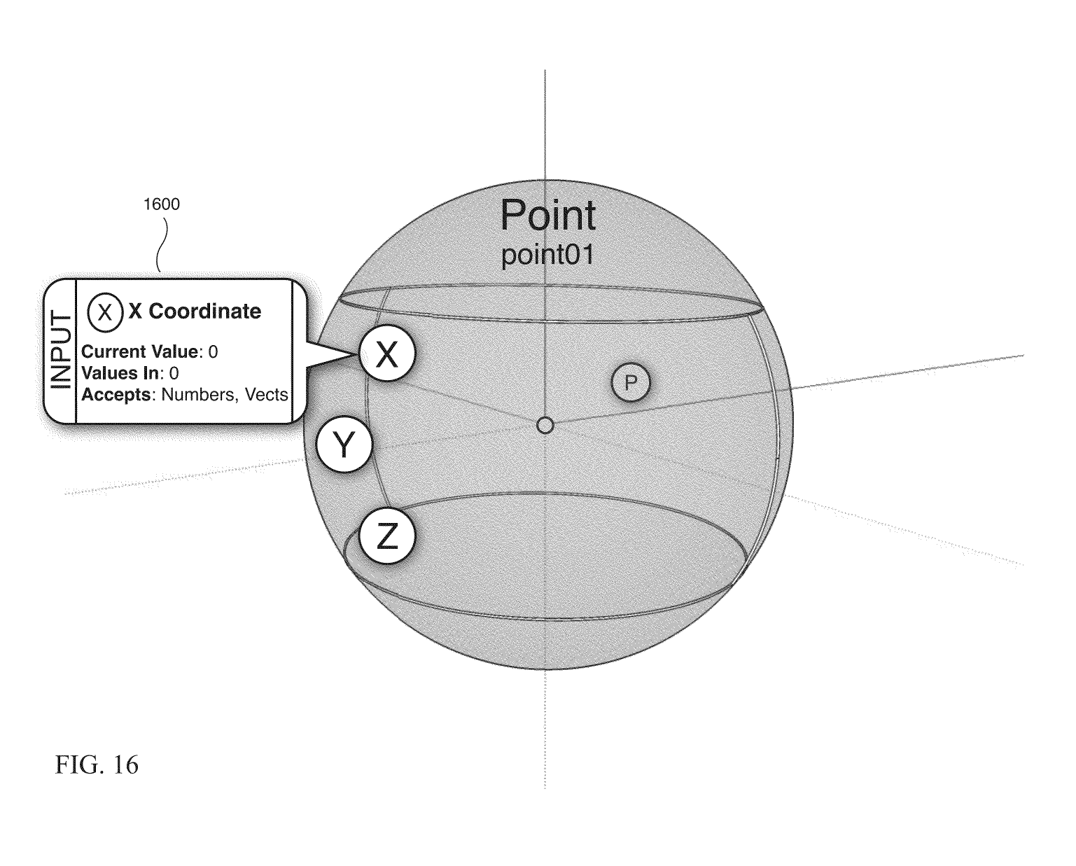

The user may query parameters of objects as illustrated in FIG. 16.

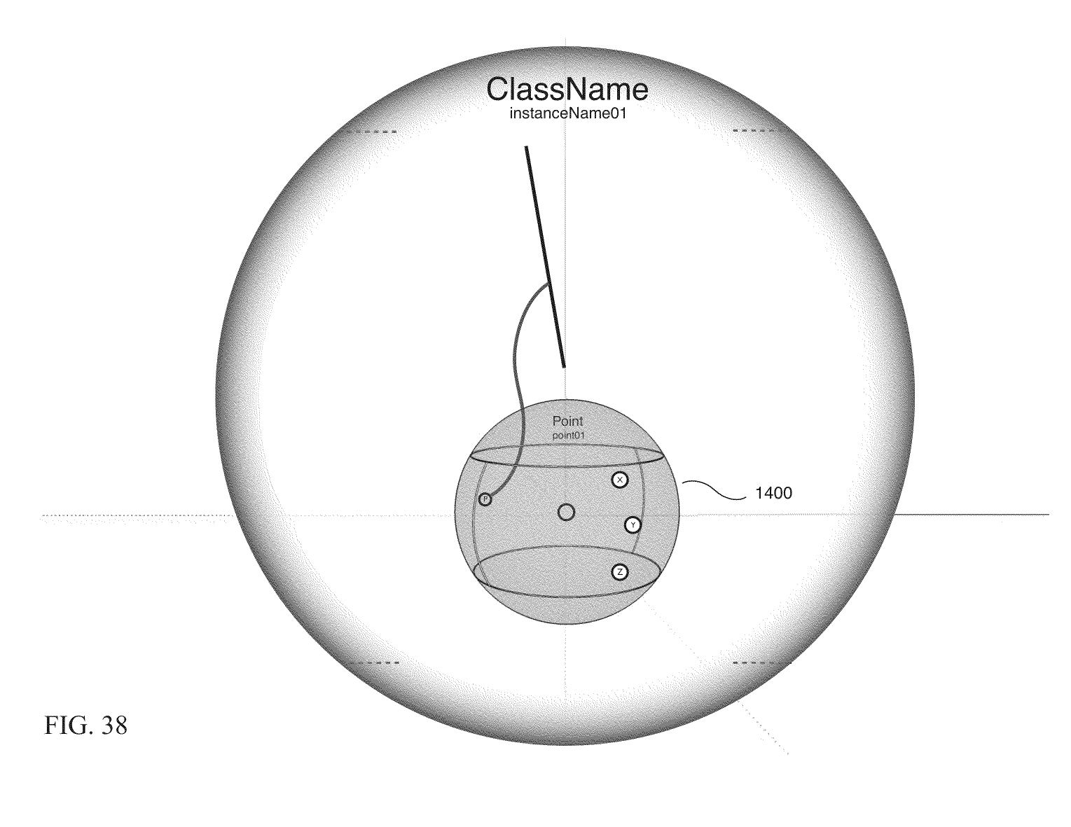

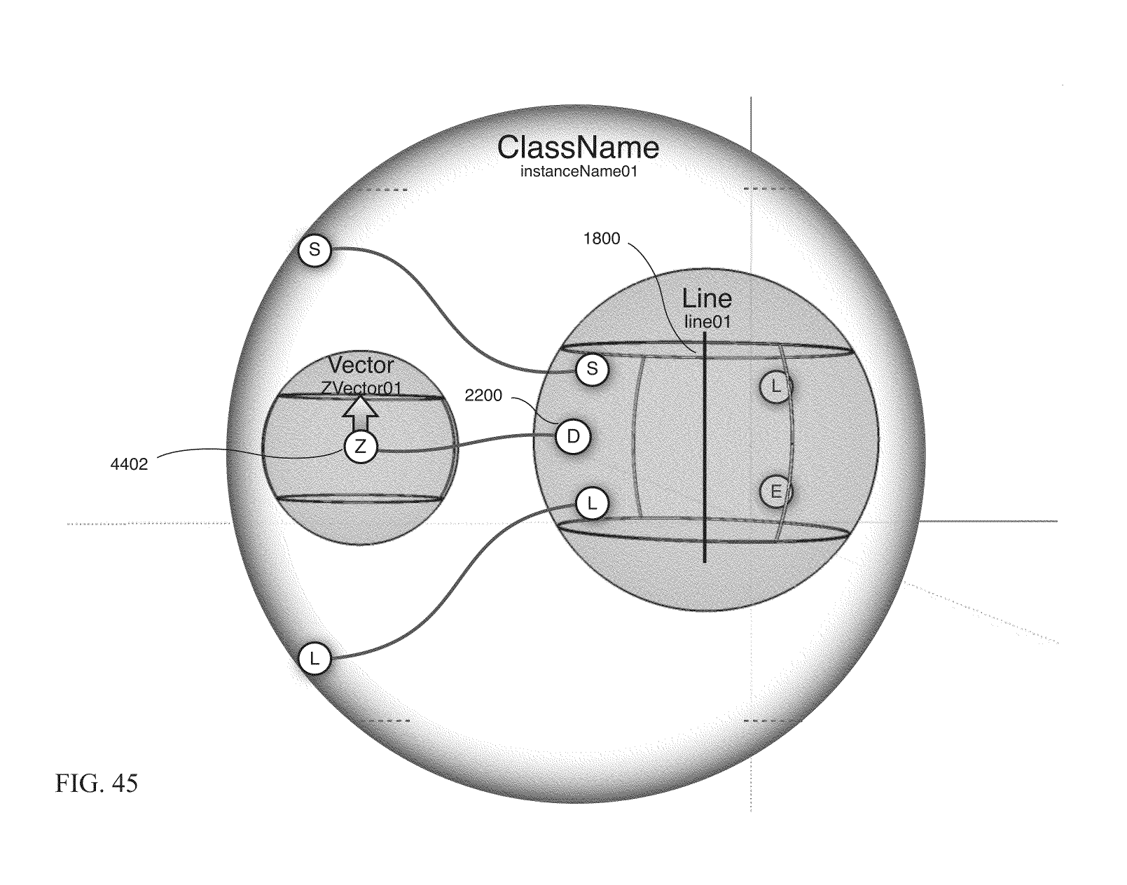

The user may enter into the interior of the bounding volume as illustrated in FIG. 45. The interior of the bounding volume 700 represents the object's implementation. Child objects may be nested within the implementation. As illustrated in FIG. 38, exploded views of child objects may be used to delineate nested objects and show parametric connections between them.

The user interface and resulting geometry may be rendered within the abstract Cartesian space 704 or composited with real-world objects to form an Augmented Reality user interface.

2. Software Architecture Overview

The technology may be implemented for execution at a mobile computing device, a desktop computing device, a server computing device (e.g., with presentation via a Web browser), or indeed any type of computing device.

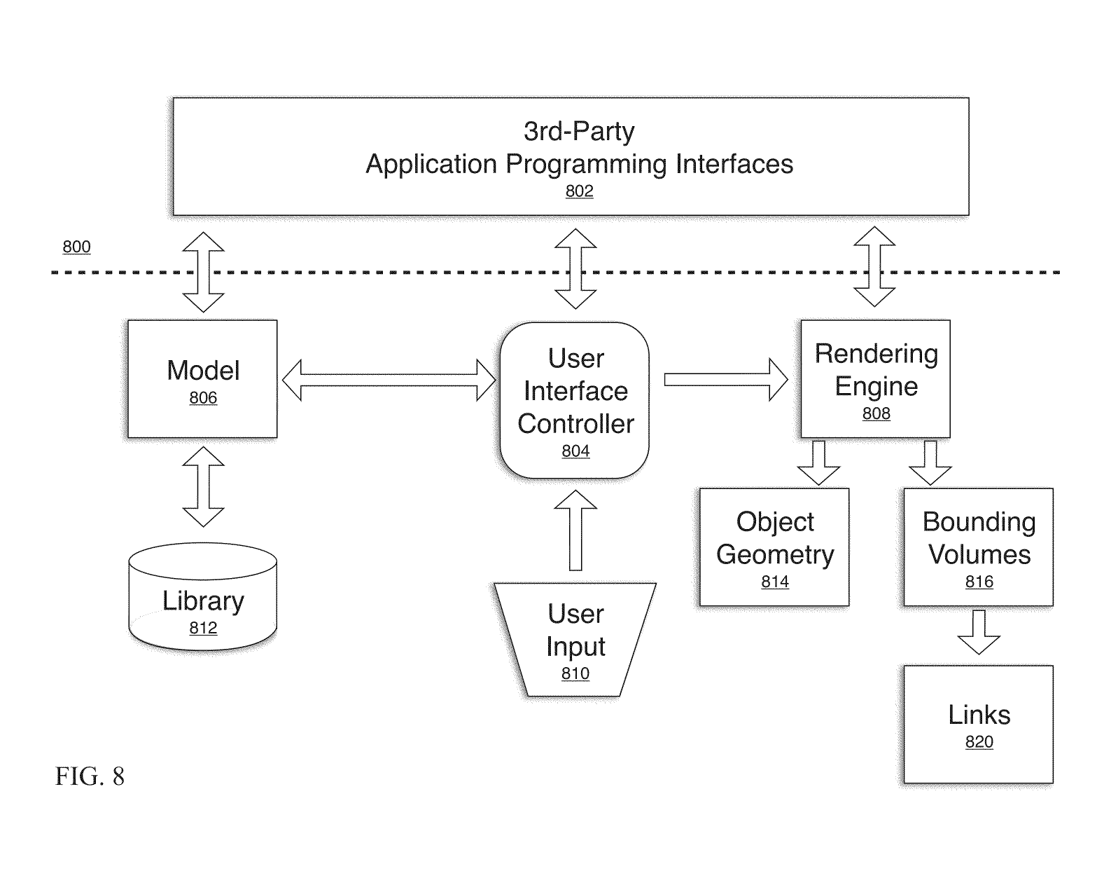

FIG. 8 illustrates an overview of the software architecture employed to create some embodiments. The architecture illustrated in FIG. 8 exhibits a Model-View-Controller design pattern. Arrows in FIG. 8 depict the direction that data can flow from one module to another in this embodiment. A dashed line 800 divides the modules of the software architecture that are specific to the proposed embodiment. Various third-party Application Programming Interfaces 802 (APIs) may be employed to provide additional functionality.

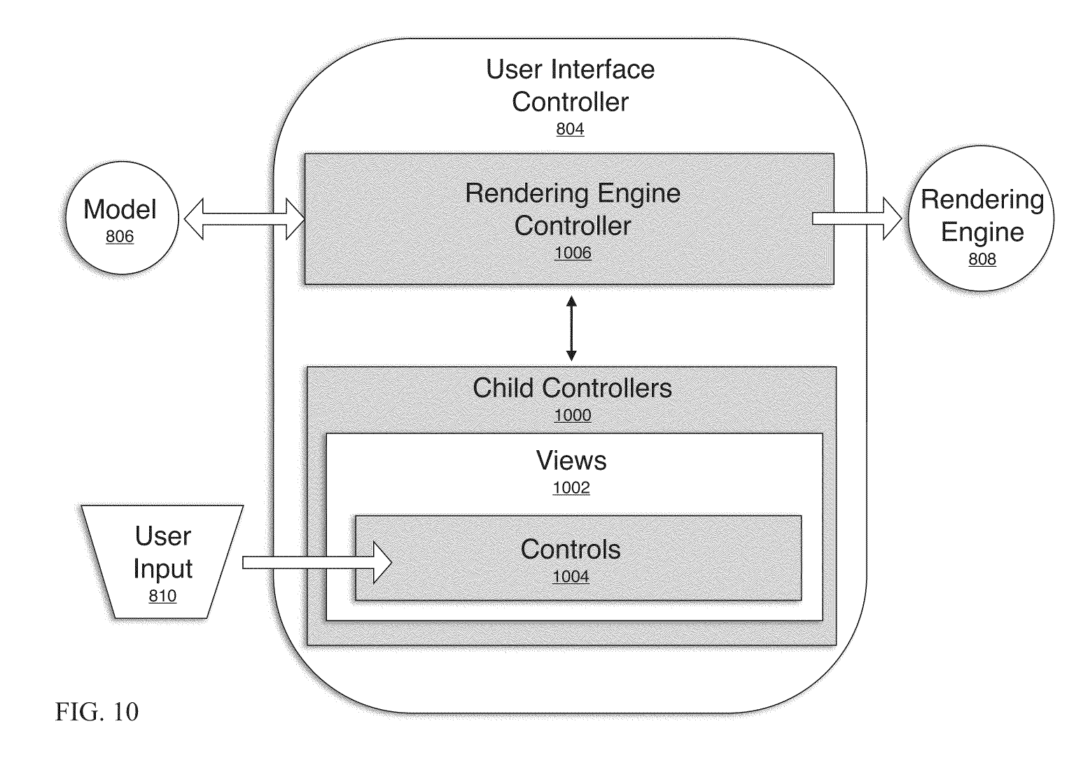

Primary control of the software is handled by a User Interface Controller 804. User Interface Controller 804 is a root controller that coordinates and structures information between a model 806, a rendering engine 808, any third-party APIs 802, and responds to user input 810. The root User Interface Controller 804 comprises child controllers 1000 as illustrated in FIG. 10. Each of these child controllers 1000 is responsible for coordinating and structuring information between their views 1002 and controls 1004. Examples of views are user interface elements that are presented to the user, e.g., class 706 or instance labels 708. Examples of controls are instances of views that respond to user-input 810, e.g., input parameters 718 and output parameters 720, or widgets. User input 810 may come in many forms including, but not limited to, keyboard keystrokes, mouse clicks, taps or gestures on a touch screen.

The User Interface Controller 804 structures communication between the model 806 and renders output to the screen (e.g., the views). Three-dimensional geometric representations, e.g., the vector 702 illustrated in FIG. 7 and their attendant bounding volume 700, are rendered by a rendering engine 808. Rendering engine 808 receives structured information from the controller 804 about a given model 806 node to be rendered and draws it to the screen. In some embodiments, a third-party OpenGL API can be used to handle communication between the rendering engine and a graphics processing unit (GPU) 1105. The rendering engine 808 renders and updates object geometry 814 and object bounding volumes 816 when displayed. Bounding volumes are rendered in a color with an alpha value less than 1.0, preferably closer to 0.35. The alpha value controls the opacity of objects to be rendered. In one possible embodiment, controls 1004 for object input parameters, such as 718, are rendered partially by the Rendering Engine 808 and partially by the child controllers 1000 that may use two-dimensional sprites to represent the parameter views. Coordination of this rendering pipeline is mediated by communication between the child controllers 1000 and the Rendering Engine Controller 1006.

A library 812 is a database of object data types stored in main memory 1106 or a storage device 1110. The library 812 can be written to a binary file format or a human readable markup format to be stored on disk. The library data types correspond, but are not limited to, the different types of nodes that are available within the software application. Communication between the library 812 and all other modules is mediated by the model 806. It is possible for a file containing a model to contain multiple libraries.

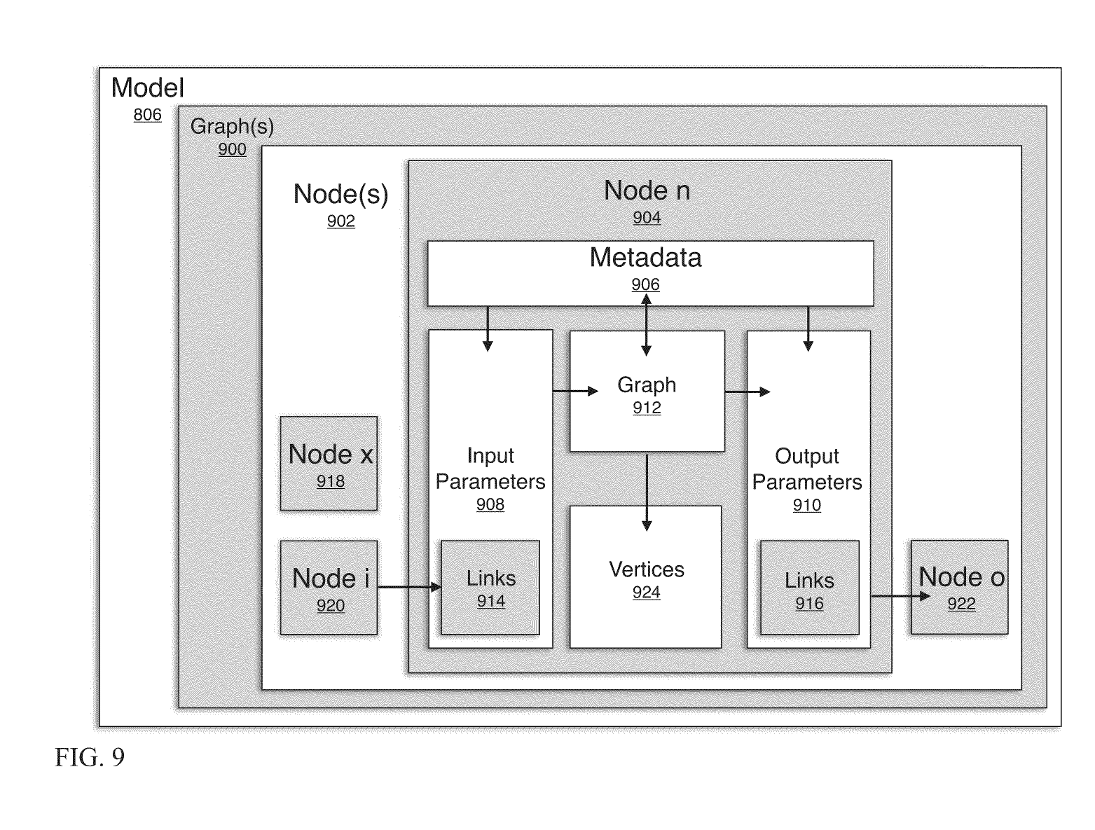

FIG. 9 illustrates an overview of the model architecture corresponding to a model 806. The model 806 contains data and business logic. Objects and their attendant views rendered onscreen are represented as nodes in the model 806. Parametric data wires rendered onscreen are represented as links in the model 806. Arrows in FIG. 9 depict the direction that data can flow from one module to another in the model. The model may contain one or many graphs 900. A graph comprises a set of nodes 902. Each node 904 comprises a set of metadata 906 about the node 904 itself. Metadata 906 includes, but is not limited to, the node's class or type, instance name, rendering style, and other classifying information. For example, a boolean metadata 906 entry may include whether or not the node's class is a member of the foundational classes of the library 812. If the node 904 is a foundational class that may determine whether or not the user can edit the implementation or a graph 912 within the node 904. A given node 904 contains a set of input parameters 908 and a set of output parameters 910. Each of the input 908 and output 910 parameters contains a set of links 914, 916. These links 914, 916 are the mechanism that connects node parameters 908, 910 and their attendant data together within the graph(s) 900. For example, a graph 900 may contain nodes x 918, i 920, n 904, and o 922. Node x 918 is not connected to any other node. Node i 920 is connected by a link 914 to an input parameter 908 in Node n 904. Node n is connected via an output parameter 910 link 916 to one of the node input parameters on Node o 922. This set of links forms a parametric relationship between node i 920 and node o 922 via node n 904.

The internal implementation logic of the node 904 is determined by the makeup of the node's graph 912. Graph 912 can contain other nodes and their associated parametric links, which in turn may contain sub-graphs. Sub-graphs are processed in a topologically sorted order as described below.

In the fashion described above, the nodes and links form a directed graph governed by the rules of graph theory. As such, the order of processing the nodes is important. All nodes in all graphs are sorted in order using a common topological sorting algorithm. A topologically ordered graph does not contain directed cycles. A cyclic graph is a graph wherein a given initial node relies on parameters from a given input node that relies on parameters from the initial node itself. The following is pseudo-code for one possible topological sorting algorithm:

L is an empty list that will contain the sorted elements
S is the set of all nodes without incoming edges
while S is non-empty do
remove a node n from S
insert n into L

for each node m with an edge e from n to m do

remove edge e from the graph
if m has no other incoming edges then
insert m into S

if graph has edges then
return error (graph has at least one cycle)
else return L (a topologically sorted order)

Once the graph has been topologically ordered, an update method may be called on the sorted graph. This update method may enumerate each node within the sorted graph calling update methods on each node. The update method of each node checks for validity of all incoming links and reports errors to 804. Once the model 806 is updated, the User Interface Controller 804 invokes update methods within the Rendering Engine Controller 1006 which may perform any number of additional sorting operations before sending geometry on to the Rendering Engine 808. Model updates may be triggered by events such as User Input 810 to a widget that affects a change in value of a parameter associated with a control.

The rendering of the bounding volume 816 is highly dependent on the shape of the embodiment. FIG. 7 depicts a spherical bounding volume. The following is pseudo-code for one possible boundary volume rendering routine:

// in graph update loop of the User Interface Controller
for each selected node n in graph G

if node n interface is exposed

retrieve node n geometry from array of vertices V
calculate bounding box of V
set bounding volume equal to bounding volume + adjustment
send bounding volume to rendering engine

The input and output parameters of a given node are rendered as parameters (e.g. 718, 720) on the bounding surface of the volume. The underlying data model 806 of the properties are the node input 908 and output 910 parameters. The rendered object itself (e.g. 702) is rendered in step 814 by the rendering engine 808 as described above. The vertices that determine the shape of the geometry are stored in the node's vertices 924. The order and configuration of the vertices 924 are determined by the values of data provided by an node input parameters 908, the node metadata 906, and the configuration of the node's internal graph 912. In some embodiments, vertices 924 are cached and bundled by the Rendering Engine Controller 1006 and sent as vertex buffer objects by the rendering engine 808 to the graphics processing unit 1105 for display. Depending on the type of geometry, nodes to be rendered may be sorted according to a node-specific variable that determines which shader to use in rendering. Multiple shaders may be employed for nodes comprising points, lines, triangles, and other visual effects for selection, shading and lighting.

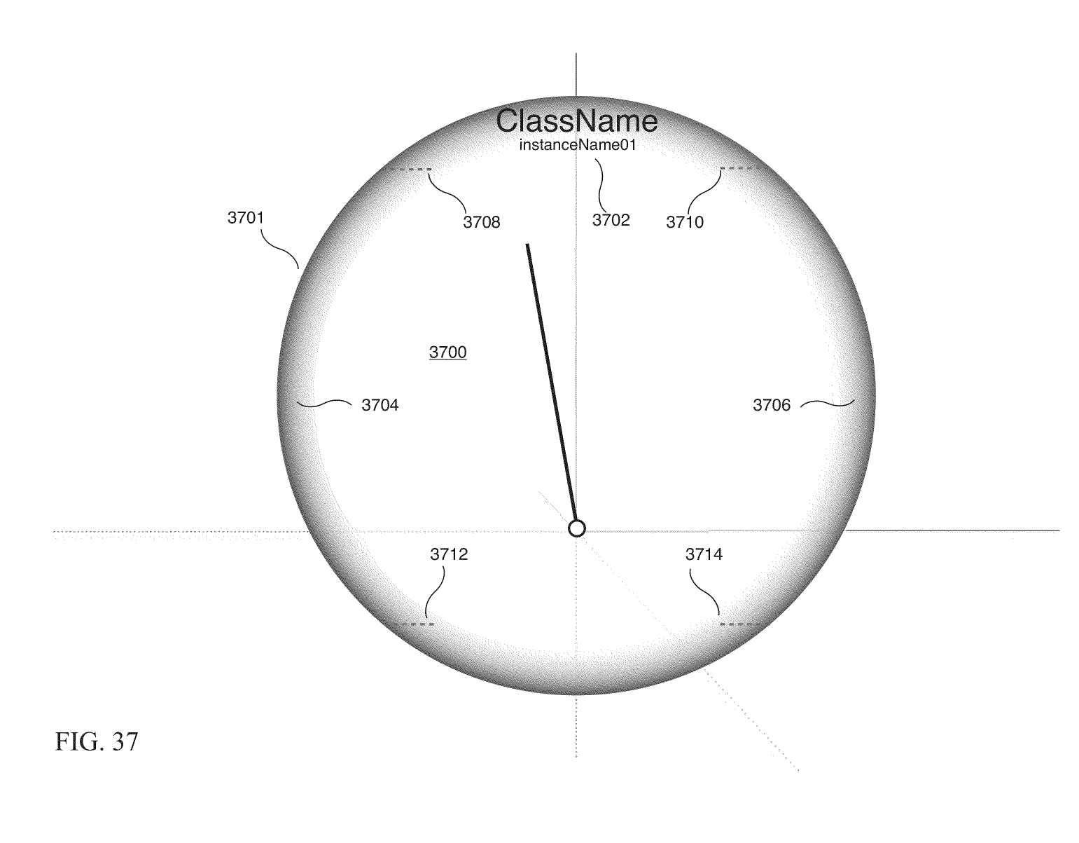

The internal implementation corresponds to the object's node's graph 912 within the model 806. When the user enters into the internal implementation of an object instance (illustrated in FIG. 37), the three-dimensional bounding volume is no longer rendered. During editing of the internal implementation, a two dimensional shape is rendered around the object to delineate it from objects outside the implementation. Child objects contained within the parent object's implementation are exploded away from each other to delineate each object. Exploded views of the child-nodes of a parent object may be achieved by any number of common methods. Translation of each child object is a simple exemplary case. The following pseudo-code is one possible example of such an explosion method:

T is a mutable array of node vertex transforms // to hold original
transforms for each node n in parent graph g

add node n vertex transforms to T

if parent node n implementation is open

for each node n in parent graph g

translate node n's vertices in direction x, y, or z from n's origin

// ...upon closing implementation
if parent node n implementation is closed

for each node n in parent graph g

translate node n to original transform in T

When the internal implementation of a child object is exposed within the internal implementation of a parent object, an additional two-dimensional bounding shape is rendered around the child object offset inside the parent bounding shape so as to create a second layer of object depth. This boundary shape should not occlude the object it contains. Other child objects of the parent object, but not contained within the child object's internal implementation, may be rendered with a separate, and visually distinct, effect or shader.

Links 914, 916 between parameters of nodes 902 in the model 806 are rendered in the view in a separate step 820 within the Rendering Engine 808. Examples of link shapes are straight lines, arcs, or bezier splines as illustrated by 3000. In rendering the links, various forms of animation may be employed to convey updates to parameter data sent through the wires.

### 3. Hardware Overview

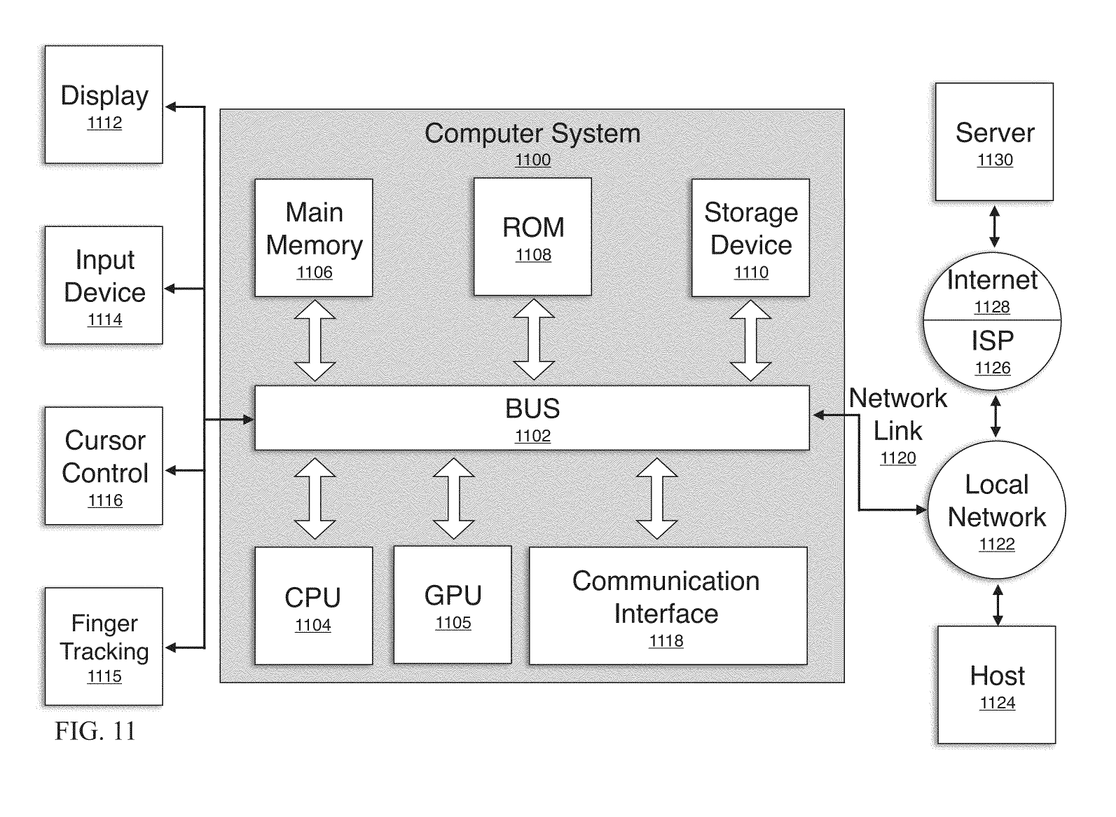

FIG. 11 is a block diagram that illustrates a computer system 1100 using which an embodiment may be implemented. Computer system 1100 includes a bus 1102 or other communication mechanism for communicating information, and a processor 1104 coupled with the bus 1102 for processing information. Computer system 1100 also includes a main memory 1106, such as random access memory (RAM), or other dynamic storage device, coupled to the bus 1102 for storing information and instruction to be executed by the processor 1104. Main memory 1106 also may be used for storing temporary variables or other intermediate information during execution of instructions to be executed by the processor 1104. Computer system 1100 further includes a read only memory (ROM) 1108 or other static storage device coupled to the bus 1102 for storing static information and instructions for processor 1104. A storage device 1110, such as a magnetic disk or optical disk, is provided and coupled to the bus 1102 for storing information and instructions.

Computer system 1100 may be coupled via the bus 1102 to a display 1112, such as a cathode ray tube (CRT) or a liquid crystal display (LCD), for displaying information to a user. An input device 1114, including alphanumeric and other keys, is coupled to the bus 1102 for communicating information and command selections to processor 1104. Another type of user input device is a cursor control 1116, such as a mouse, trackball, or cursor direction keys for communicating direction information and command selections to the processor 1104 and for controlling cursor movement on the display 1112. This input device typically has two degrees of freedom in two axes: a first axis (e.g., x) and a second axis (e.g., y), that allows the device to specify positions in a plane. Other examples of user input devices are a human finger 1115 or a stylus on a capacitive touch screen.

The system, method, and user interface are related to the use of the computer system 1100 for designing, modeling and interacting with three-dimensional objects. According to some embodiments, a design and modeling application is provided by the computer system 1100 in response to the processor 1104 executing one or more sequences of one or more instructions contained in main memory 1106. Such instructions may be read into main memory 1106 from another computer-readable medium, such as storage device 1110. Execution of the sequences of instructions contained in main memory 1106 causes the processor 1104 to perform the process steps described herein. One or more processors in a multi-processing arrangement may also be employed to execute the sequences of instructions contained in main memory 1106. Hard-wired circuitry for a graphics processing unit 1105 may be used in place of or in combination with software instructions to implement an embodiment. Thus, embodiments are not limited to any specific combination of hardware circuitry and software.

The term “computer-readable medium” as used herein refers to any medium that participates in providing instructions to the processor 1104 for execution, including transitory media and storage media (e.g., non-transitory media). Computer-readable media may take many forms, including but not limited to, non-volatile media, volatile media, and transmission media. Non-volatile media include, for example, optical or magnetic disks, such as storage device 1110. Volatile media include dynamic memory, such as main memory 1106. Transmission media include coaxial cables, copper wire and fiber optics, including the wires that comprise bus 1102. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 1104 for execution. For example, the instructions may initially be borne on a magnetic disk of a remote computer. The remote computer can load the instructions into its dynamic memory and send the instructions over a telephone line using a modem, a cellular network, or an internet connection. A modem local to the computer system 1100 can receive the data on the telephone line and use an infrared transmitter to convert the data to an infrared signal. An infrared detector coupled to the bus 1102 can receive the data carried in the infrared signal and place the data on the bus 1102. Bus 1102 carries the data to main memory 1106, from which the processor 1104 retrieves and executes instructions. The instructions received by main memory 1106 may optionally be stored on storage device 1110 either before or after execution by the processor 1104.

Computer system 1100 also includes a communication interface 1118 coupled to the bus 1102. Communication interface 1118 provides a two-way data communication coupling to a network link 1120 that is connected to a local network 1122. For example, the communication interface 1118 may be an integrated services digital network (ISDN) card or a modem to provide a data communication connection to a corresponding type of telephone line. As another example; the communication interface 1118 may be a local area network (LAN) card to provide a data communication connection to a compatible LAN. Wireless links may also be implemented. In any such implementation, the communication interface 1118 sends and receives electrical, electromagnetic or optical signals that carry digital data streams representing various types of information.

Network link 1120 typically provides data communication through one or more networks to other data devices. For example, the network link 1120 may provide a connection through a local network 1122 to a host computer 1124 or to data equipment operated by an Internet Service Provider (ISP) 1126. ISP 1126 in turn provides data communication services through the Internet 1128. Local network 1122 and Internet 1128 both use electrical, electromagnetic or optical signals that carry digital data streams. The signals through the various networks and the signals on network link 1120 and through the communication interface 1118, which carry the digital data to and from the computer system 1100, are exemplary forms of carrier waves transporting the information.

Computer system 1100 can send messages and receive data, including program code, through the network(s), network link 1120, and communication interface 1118. In the Internet example, a server 1130 might transmit a requested code for an application program through Internet 1128, ISP 1126, local network 1122 and the communication interface 1118. One such downloaded application provides for storing and retrieving persistent objects as described herein. The received code may be executed by the processor 1104 as it is received, and/or stored in the storage device 1110, or other non-volatile storage for later execution. In this manner, the computer system 1100 may obtain application code in the form of a carrier wave.

### Operation

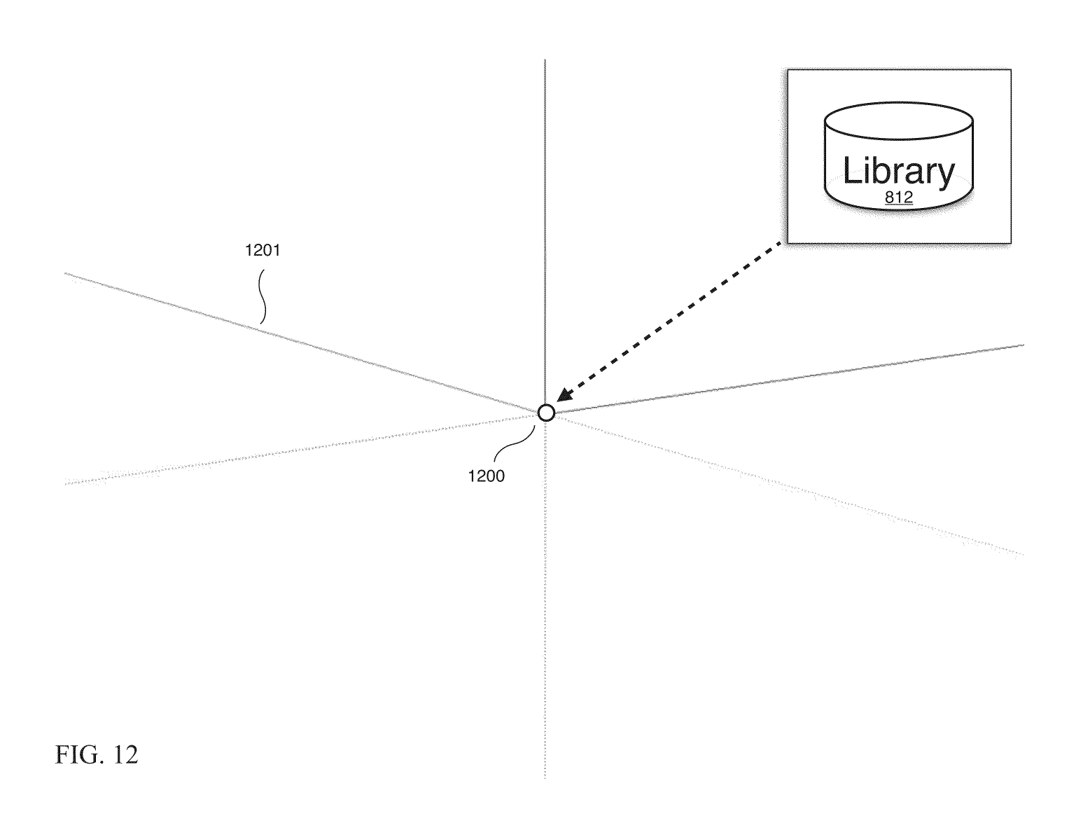

To illustrate the use of some embodiments of the software application, consider the case of creating a class of parametric line that is constrained to the z-axis. FIG. 12 through FIG. 50 depict this process from start to finish.

FIG. 12 illustrates a perspective window viewing a Cartesian space 1201. The user may begin by adding an instance of an object 1200 from a library 812 of classes to the three-dimensional Cartesian space 1201. The classes in the library 812 can be a predefined set of foundation classes or user-generated classes. An example of a foundational geometry class is a point 1200. The user can add the point to the Cartesian space 1201 by any number of possible methods, including, but not limited to, keyboard commands, dragging with a mouse from a menu of objects, or gestures on a touch screen.

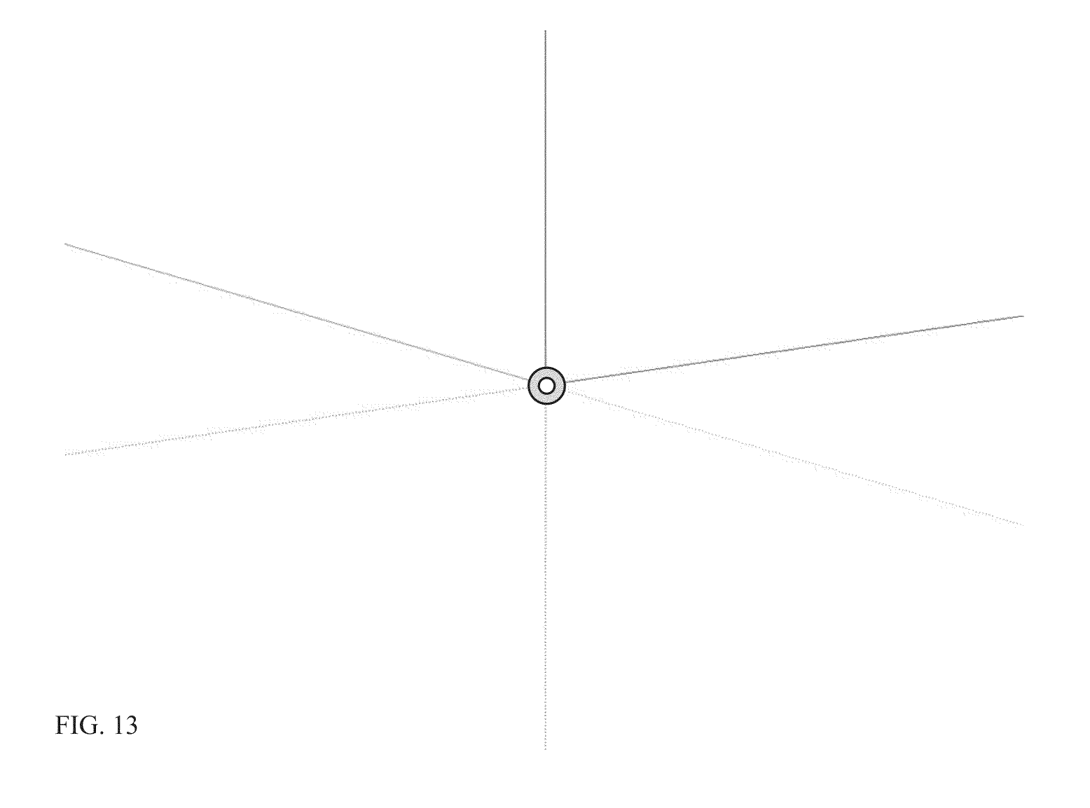

FIG. 13 illustrates the point object selected. The user may select the point by any number of methods including, but not limited to, a mouse click or finger-tap on a touch screen. Once the object is selected, the user can choose to display the object's interface by any number of methods including, but not limited to, a mouse double-click or a double-tap of a finger on a touch screen.

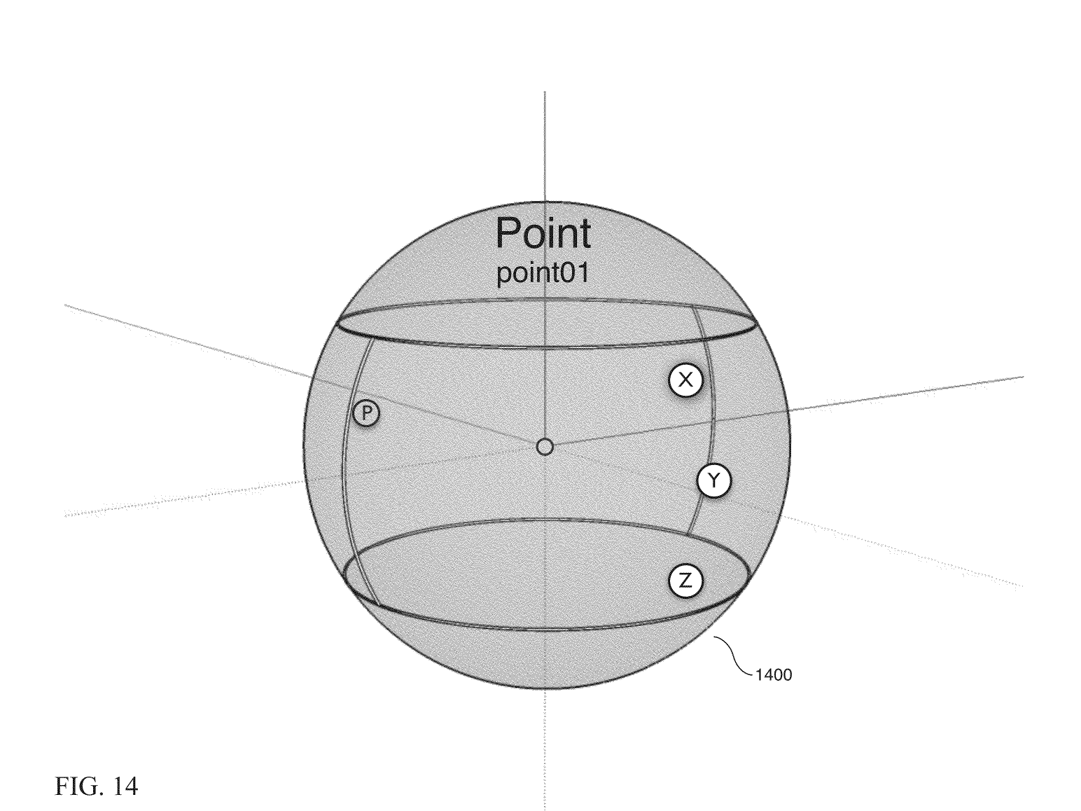

FIG. 14 illustrates the object's interface rendered as a bounding volume 1400. In one possible embodiment, the geometry is a sphere that encompasses the bounding area of the object. The size of the bounding volume of the object may be determined by the smallest possible bounding area of the object plus some predefined fraction of the volume, or by the number of input and output parameters of the object, or both.

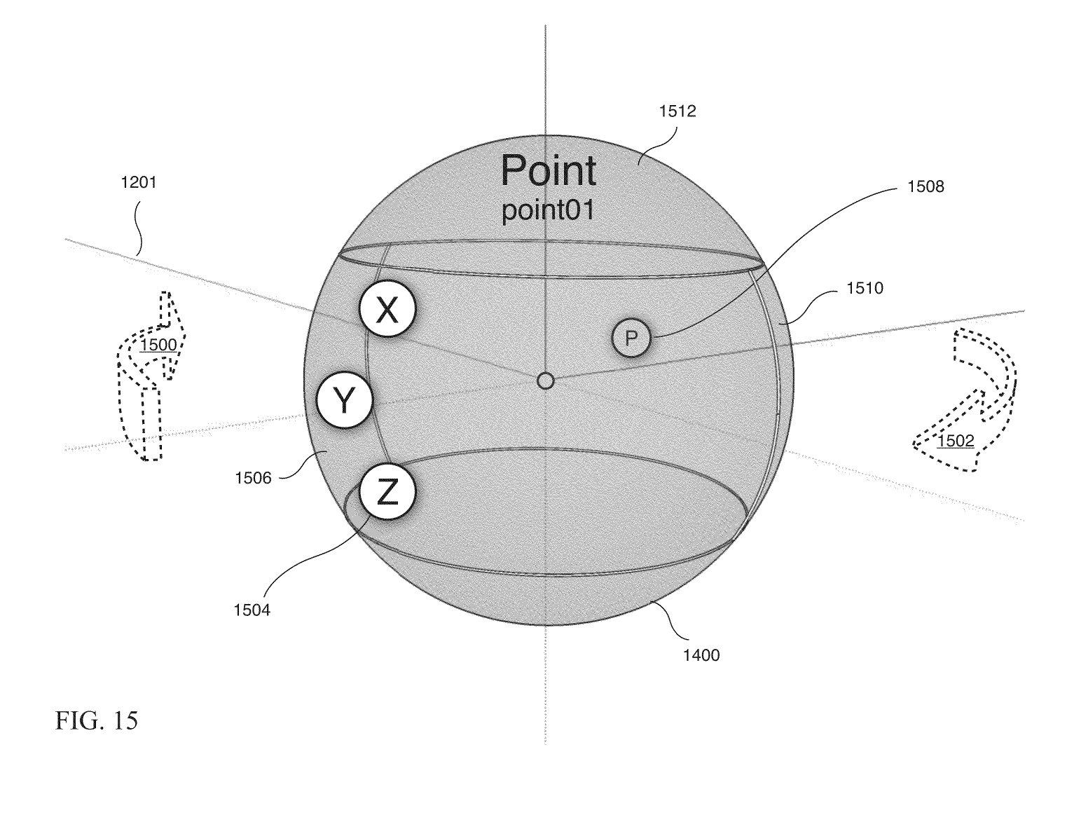

FIG. 15 illustrates the result of the user rotating the point's interface bounding geometry 1400. Dashed arrows 1500, 1502 represent possible axes of rotation. Once the parametric interface of the object is visibly rendered in the viewport, the user can rotate the bounding volume 1400 by any number of methods including, but not limited to, clicking and dragging on the surface with a mouse, a finger, or a stylus. Rotation and zooming of the bounding volume can be used as a method for the user to understand the parametric inputs and outputs that govern the object. Depending on the shape of the bounding volume, some form of interpolation can be used to determine the rotational position of the bounding volume relative to the user perspective. For example, in an embodiment where the bounding volume is a sphere, spherical linear interpolation would be employed to rotate the bounding volume relative to the position of the user view and the user input. When the interface of an object is exposed and rendered onscreen, the zoom scale of the object's bounding volume 1400 and the data it displays is relative to and contingent upon the perspectival zoom scale of the surrounding Cartesian space 1201. In this fashion, the bounding volume can constitute a zoomable user interface in three dimensions. The user can rotate the bounding volume 1400 to view different parameters more closely. For example, the user can rotate the bounding volume 1400 to better view the input parameters 1504 in the input zone 1506. Alternatively, if the user desires to see what properties the object returns, the user can rotate the bounding volume 1400 to view the output parameters 1508 in the output zone 1510. Should the user want to know what class the instance belongs to, the user can rotate and/or zoom to the identity zone 1512 of the object's bounding volume.

FIG. 16 illustrates the system for querying an object's properties/parameters. Should the user wish to further query an object's parameter, the user can click or tap the exposed parameter to bring up such information 1600 as the parameter's data type, the number of input or output links to the parameter, or whether the parameter is read-write or read-only. These parameter information views can be dismissed at any time or automatically should the user's interaction focus change to another parameter or another object entirely.

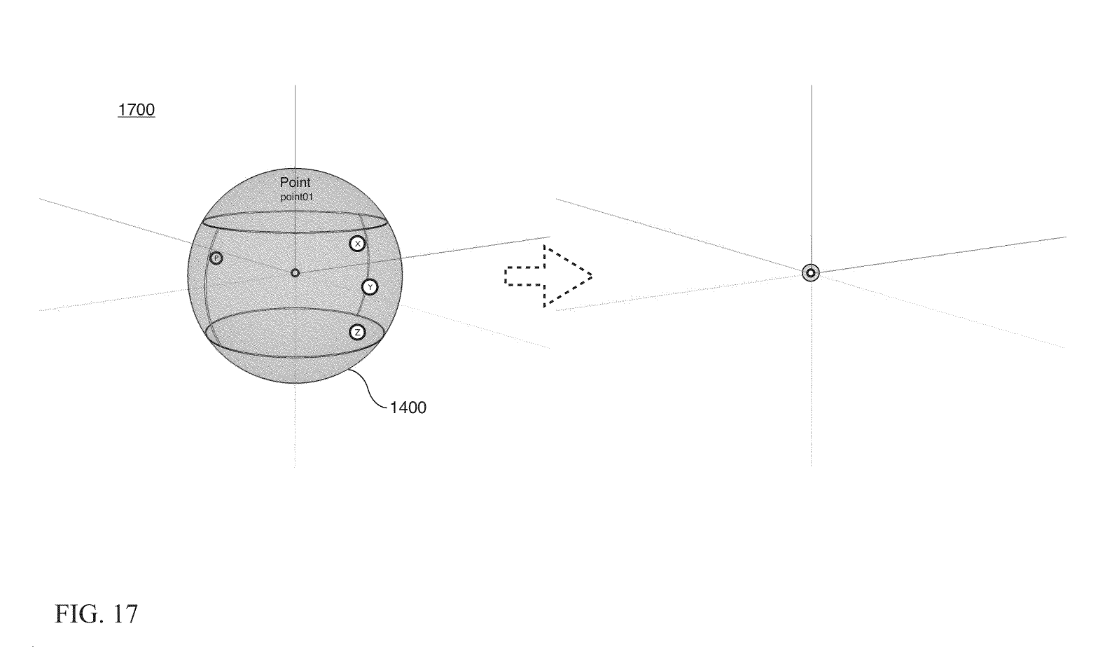

FIG. 17 illustrates how the user can dismiss the bounding volume 1400 by interacting in empty space 1700 outside the limits of the boundary volume 1400. This effectively closes or hides the parametric interface of the object until requested again. Note that the object remains selected as shown on the right side of FIG. 17. The user can dismiss the selection of the object by again tapping or clicking in the area 1700 outside the object.

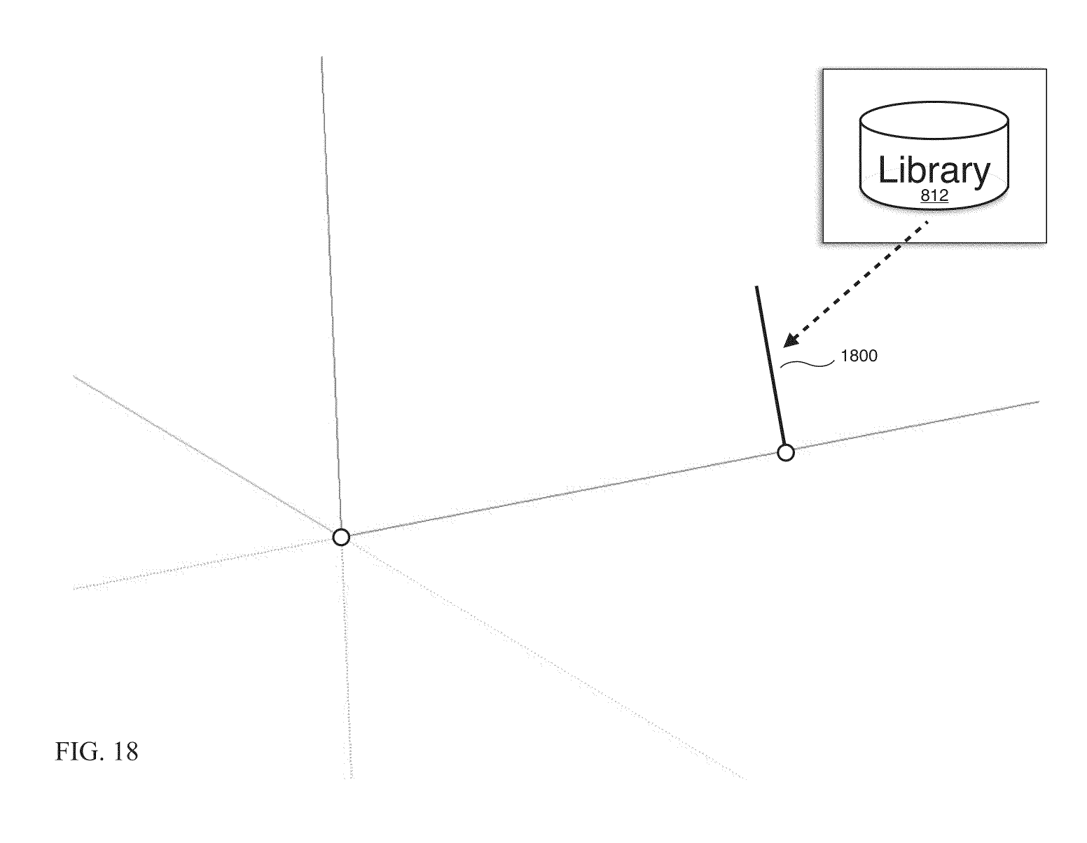

FIG. 18 illustrates the addition of a second object to the model. In this case, the user has added a line object 1800 from the library 812.

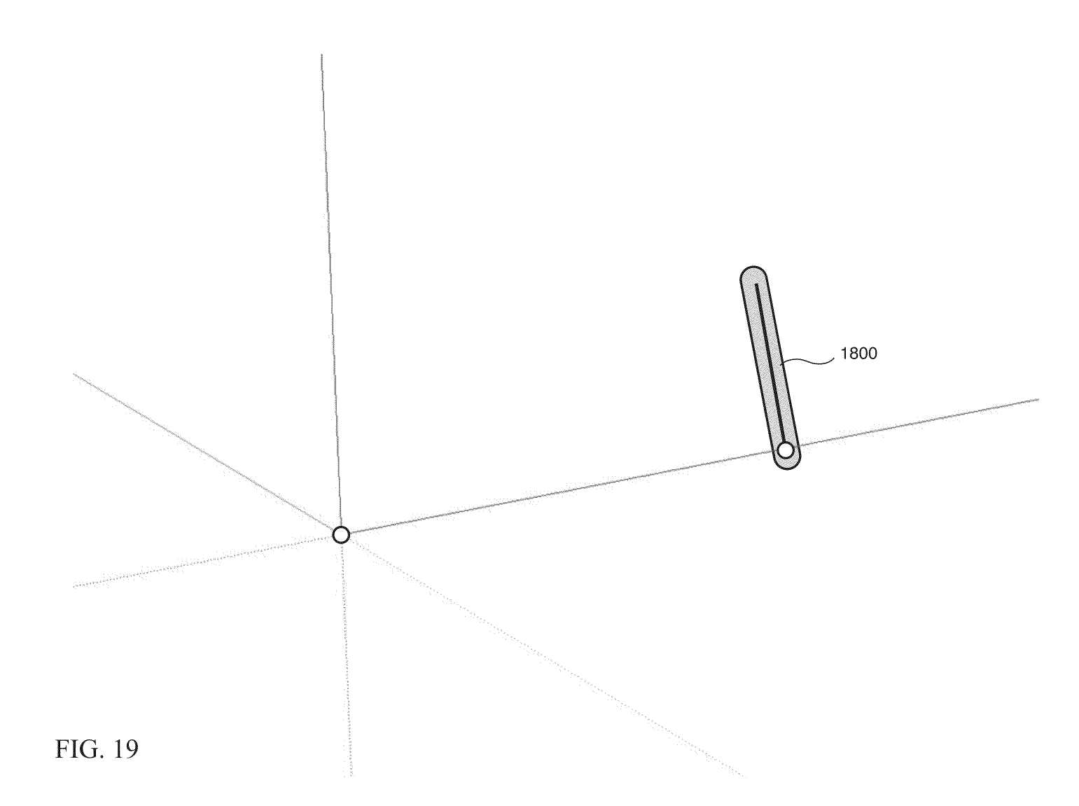

In a similar fashion to that illustrated in FIG. 13, FIG. 19 illustrates the selection of the line object 1800.

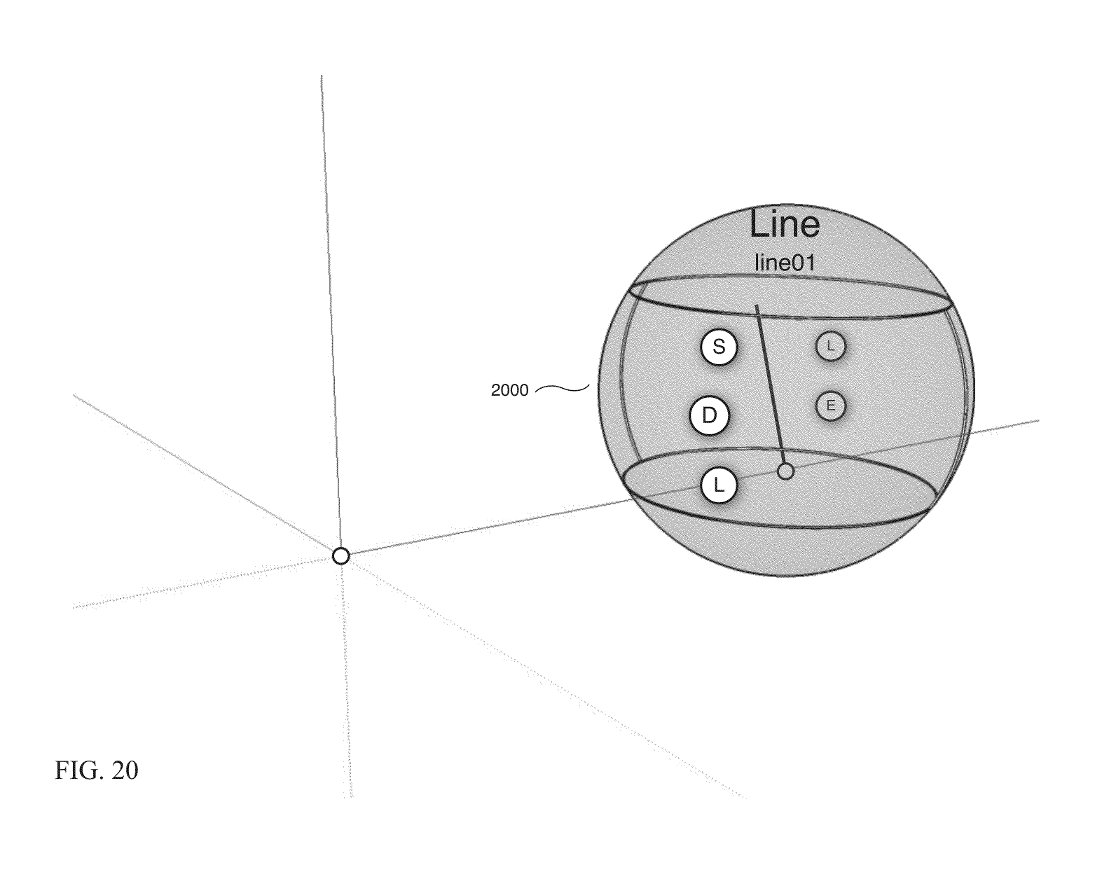

With the line object 1800 selected, the user may then expose the line object's parametric interface 2000 as illustrated in FIG. 20.

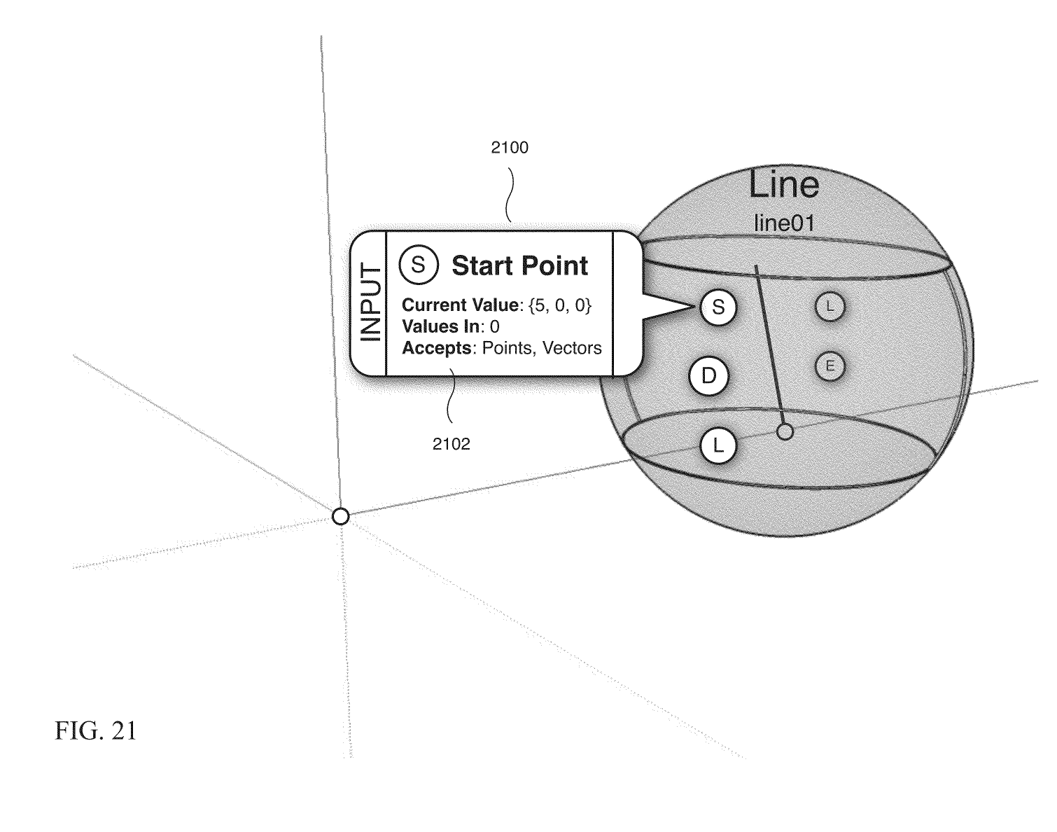

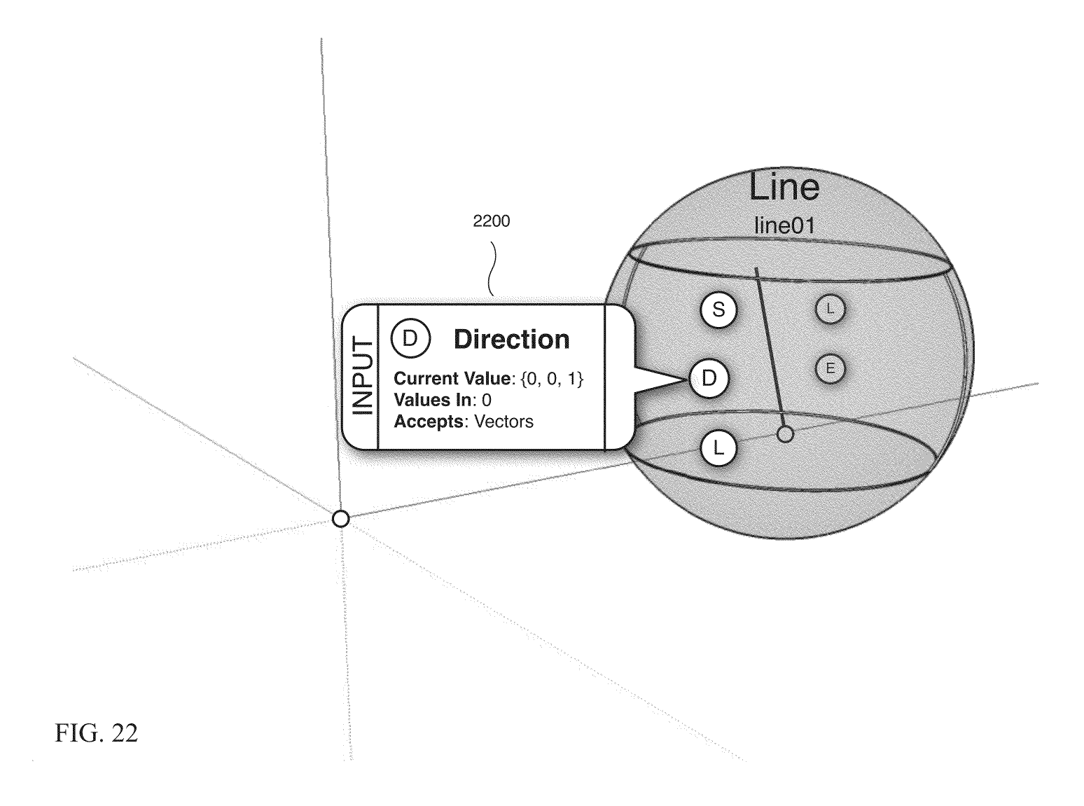

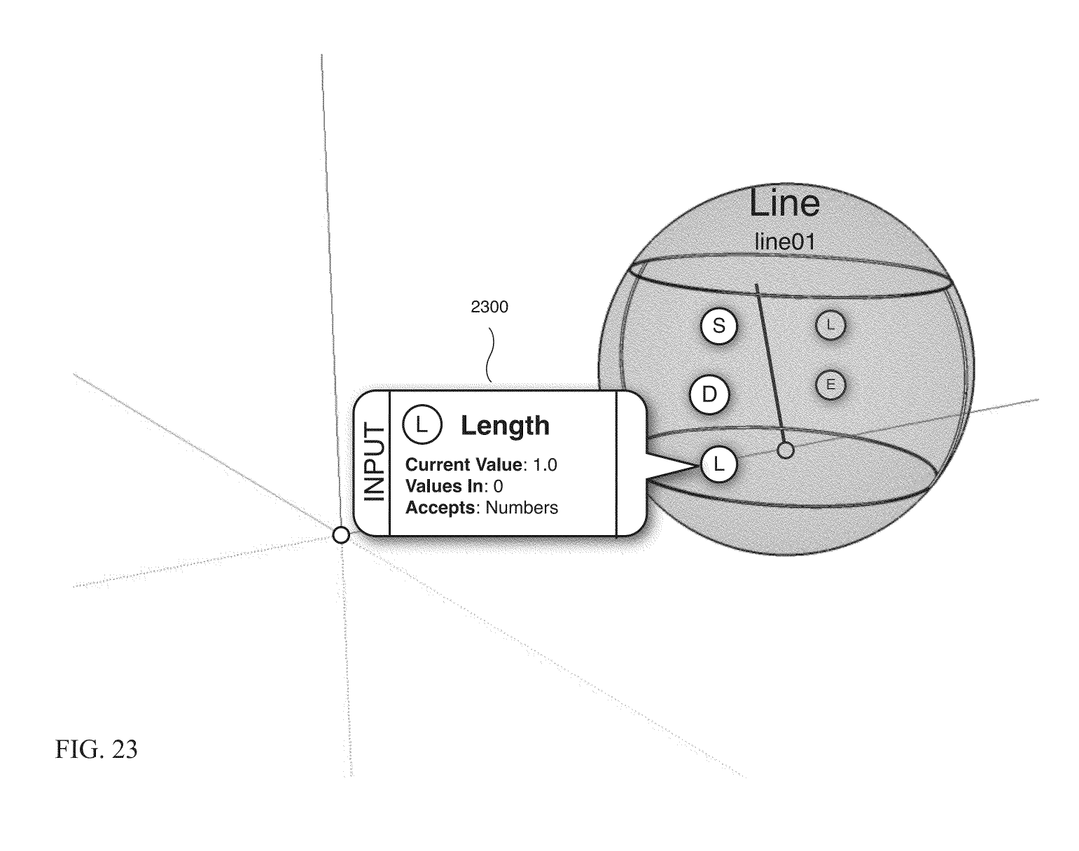

FIG. 21 through FIG. 23 illustrate the user in the process of querying each input parameter of the line instance. This line class accepts three input parameters: a start point 2100, a direction 2200, and a length 2300. FIG. 21 illustrates the line instance's first input parameter, Start Point 2100. Information about the values contained in the parameter are displayed to the user, along with the types of data the parameter accepts as inputs 2102. In this case, the start point 2100 input parameter will accept other parameters of type Point or Vector. FIG. 22 illustrates the line instance's second input parameter, direction 2200 and its corresponding information. FIG. 23 illustrates the line instance's third input parameter, length 2300. Taken together, these three input parameters represent the necessary data to create a parametric line instance. Any data linked into these input parameters of the appropriate type will cause the node representing this object to update its values.

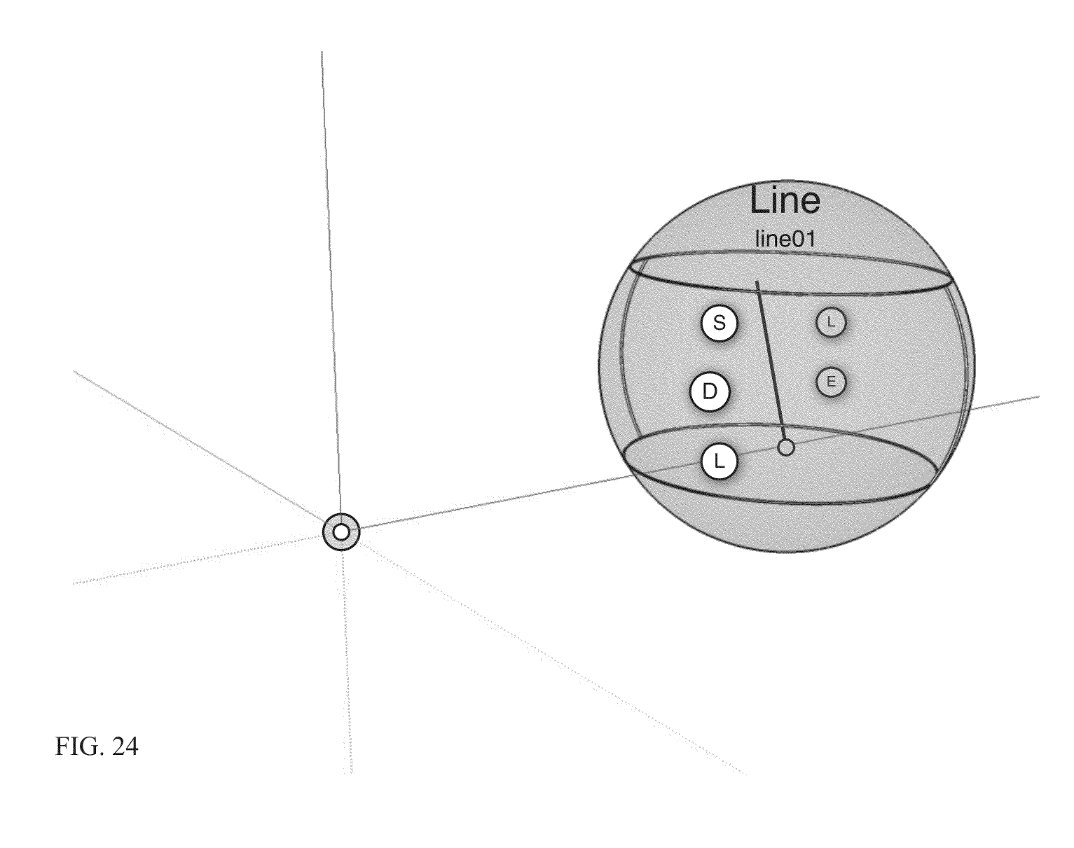

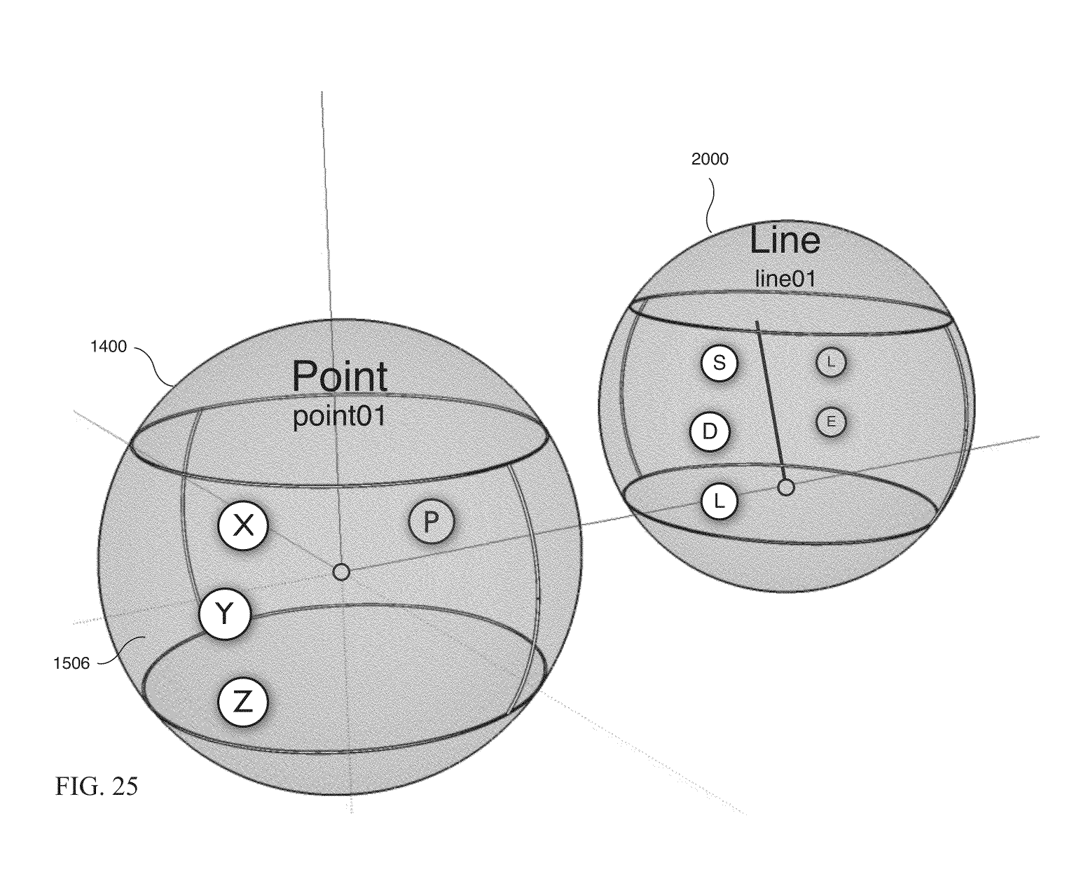

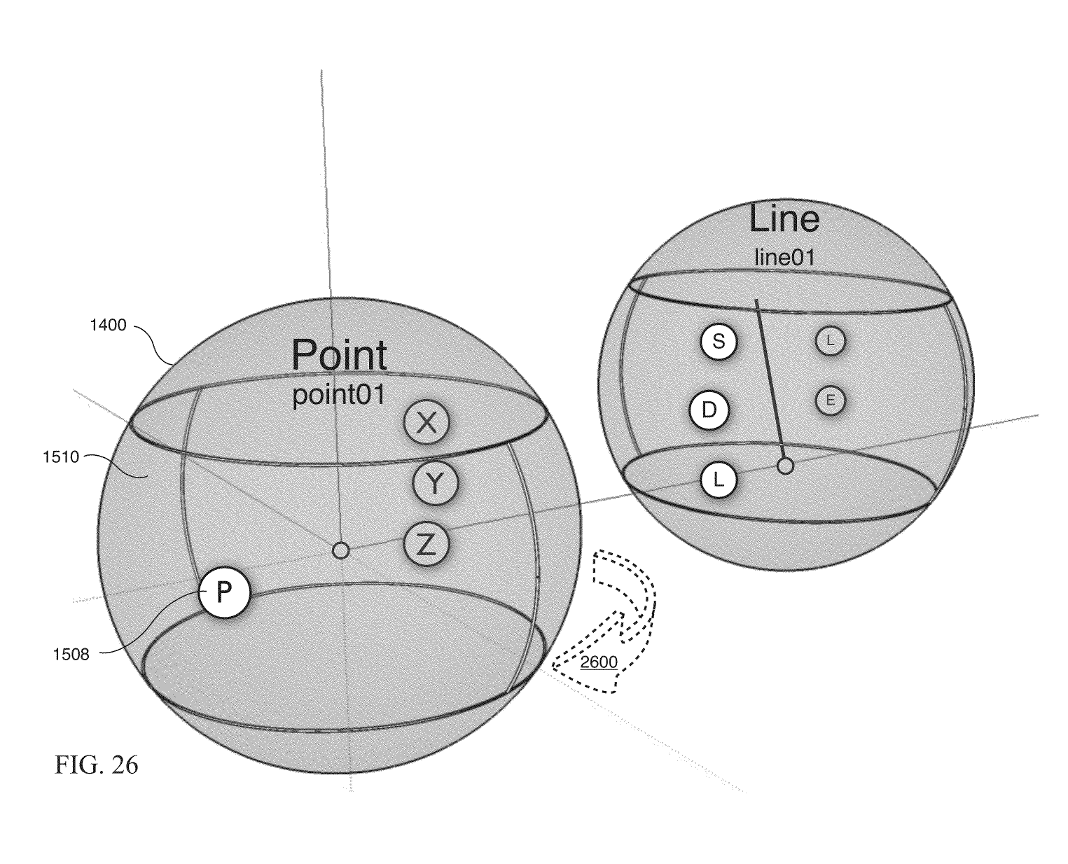

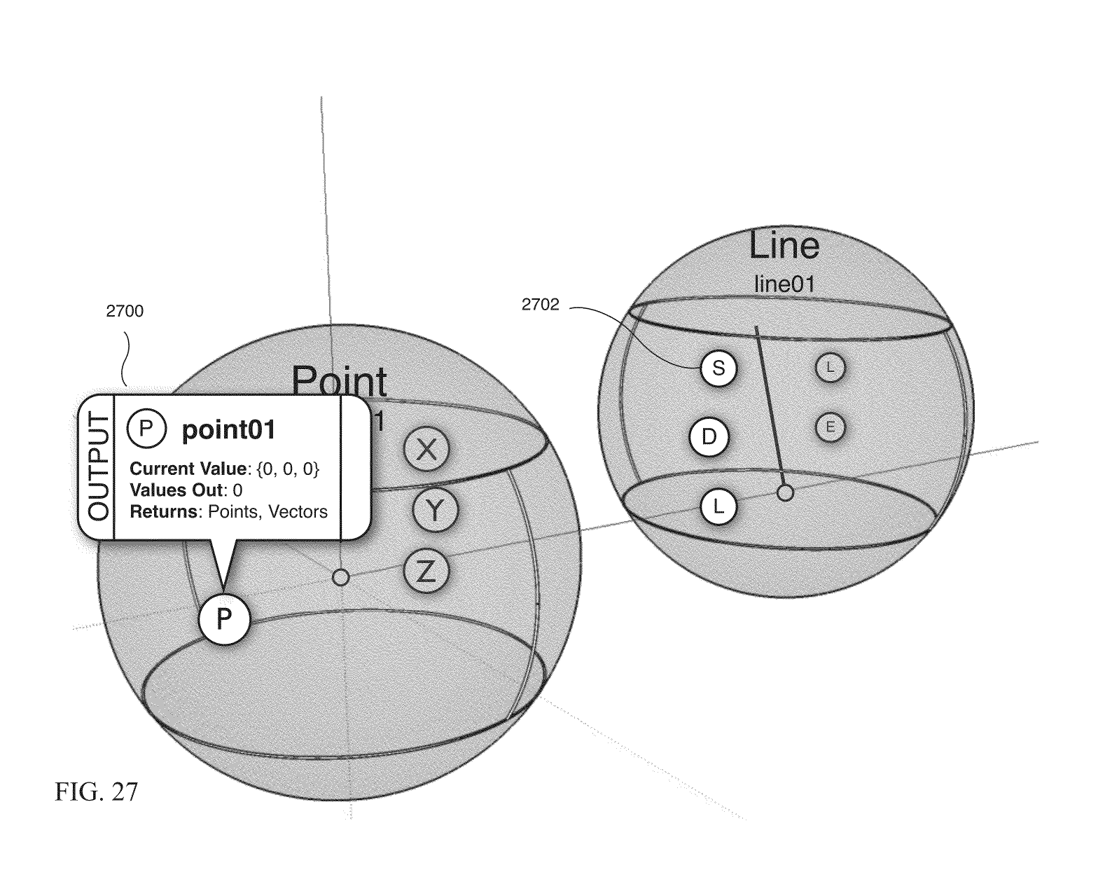

The user now wishes to create a parametric link between the first point instance 1200 and the start point of the line 2100. The user selects the point object as depicted in FIG. 24. FIG. 25 illustrates the user exposing the point instance's bounding volume 1400 in a similar fashion to that described in FIG. 14. Note that the line's interface 2000 remains visible to the user and that the point's bounding volume 1400 input zone 1506 is currently facing the user. In FIG. 26, the user rotates 2600 the point bounding volume 1400 so as to show the output zone 1510 and an output parameter 1508 therein. The user may now query an output parameter 2700 as shown in FIG. 27. In this case, the point class returns a single parameter, which is the point itself. This is an appropriate input for a start point parameter 2702 of the line instance.

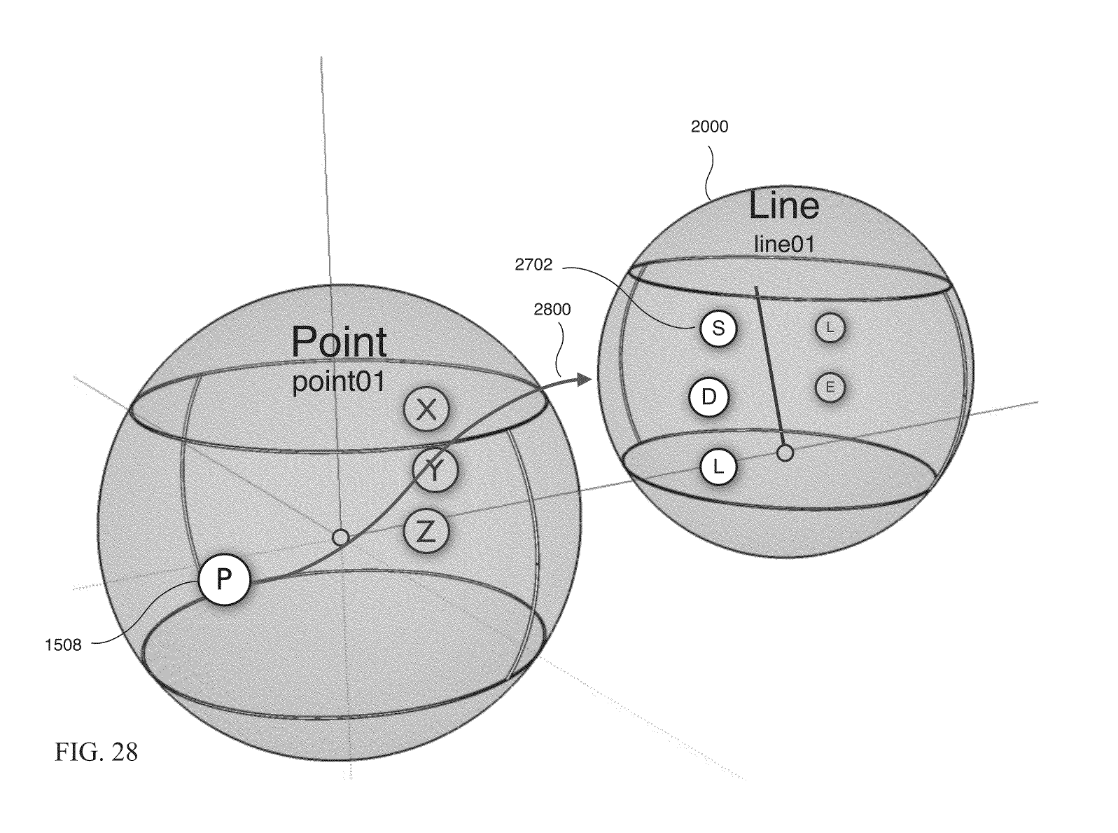

FIG. 28 illustrates the user starting to make a parametric link from the point output parameter 1508. In this case, the user wishes to make a connection between the point parameter 1508 and the start point parameter 2702 on the line interface 2000. As the user drags a link 2800, a wire is rendered onscreen between the point output parameter 1508 and the location of the user's mouse cursor, touch-point, or other pointing device.

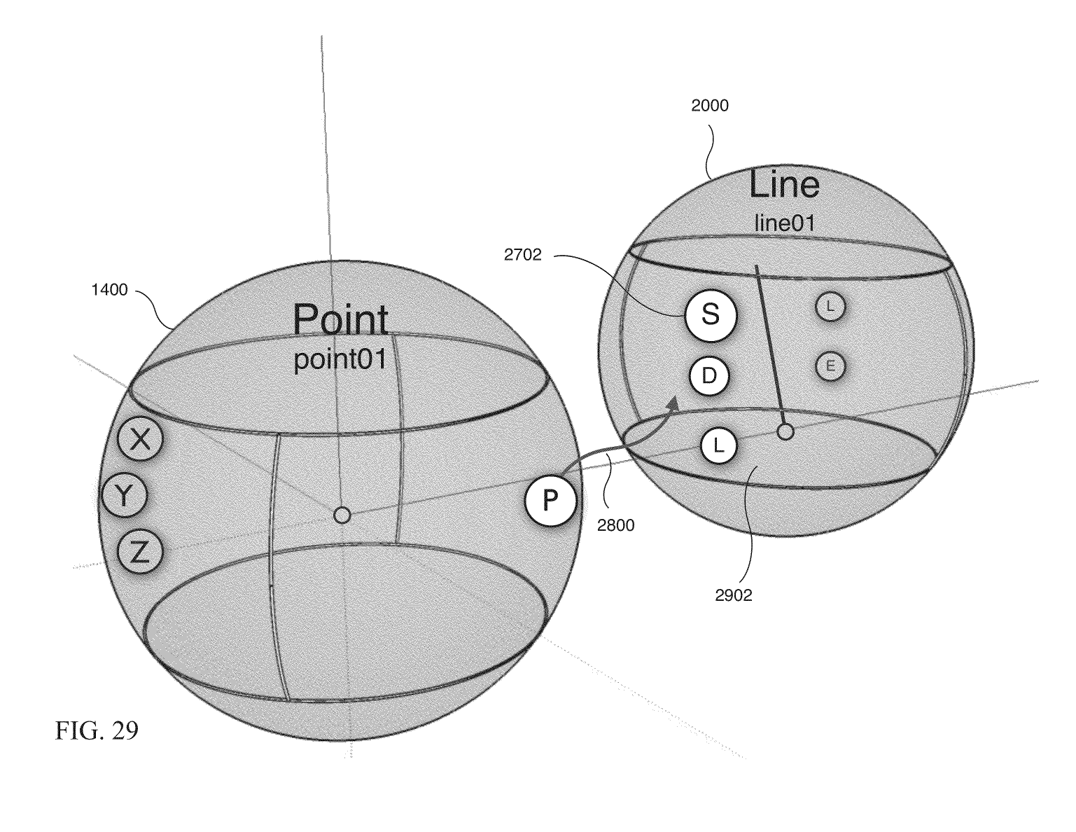

FIG. 29 illustrates the user in the process of dragging a link from the point parameter. The bounding volume 1400 of the point object rotates in the direction of the location of the user's mouse cursor, touch-point, or other pointing device. As the end of the link 2800 is nearing the interface 2000 of the line object, the input zone 2902 of the line interface 2000 is rotated to face the end of the link 2800. Since the parameter 1508 being dragged is of type Point, the object with the nearest bounding volume to the current location of the end of the link 2800 executes a check of all input parameters against the incoming type. If the type of the input parameter matches the type of the incoming parameter, the input parameter 2702 is scaled larger and moved closer to the end of the link 2800 being dragged. This process of type-matching is an aid to the user in finding appropriate input parameters. If the user moves the end of the link away from the interface 2000, the input parameters are scaled to normal scale and moved to their original location on the interface 2000.

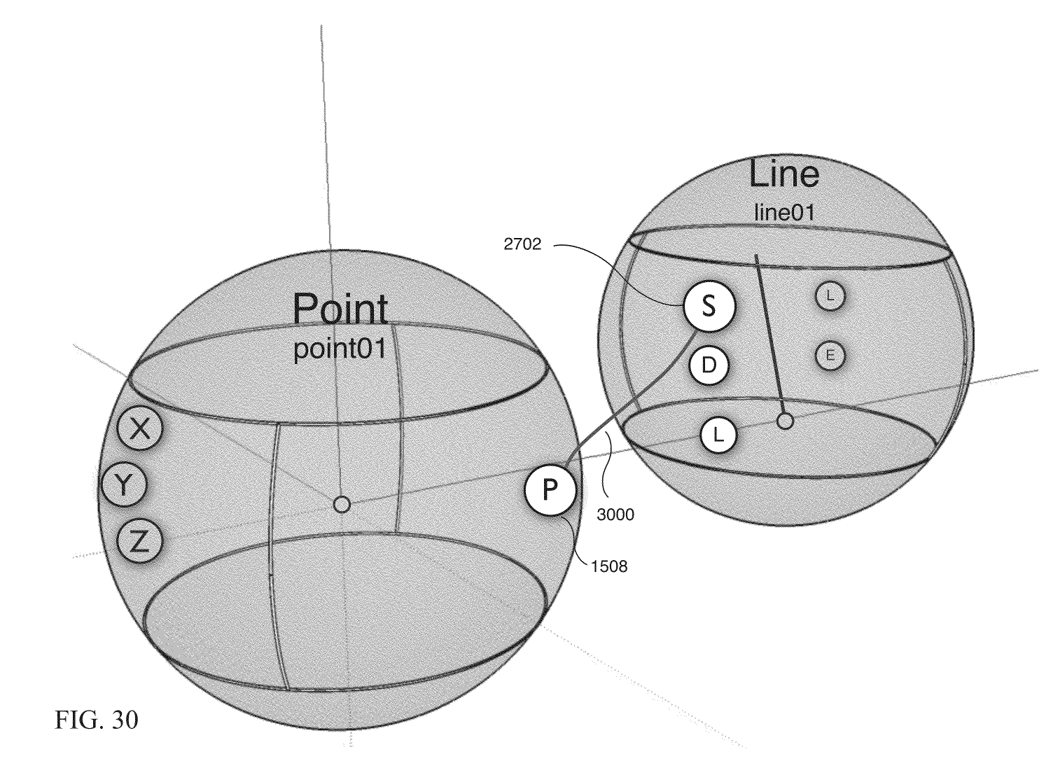

FIG. 30 illustrates the result of making a parametric link between the point parameter 1508 and the start point input parameter 2702. The two parameters are connected by a link 3000. It is possible to make parametric connections between differently typed parameters, however an error is reported to the user to indicate that the parametric link is faulty and the node 904 representing the object receiving the incoming parameter is not updated in the model 806.

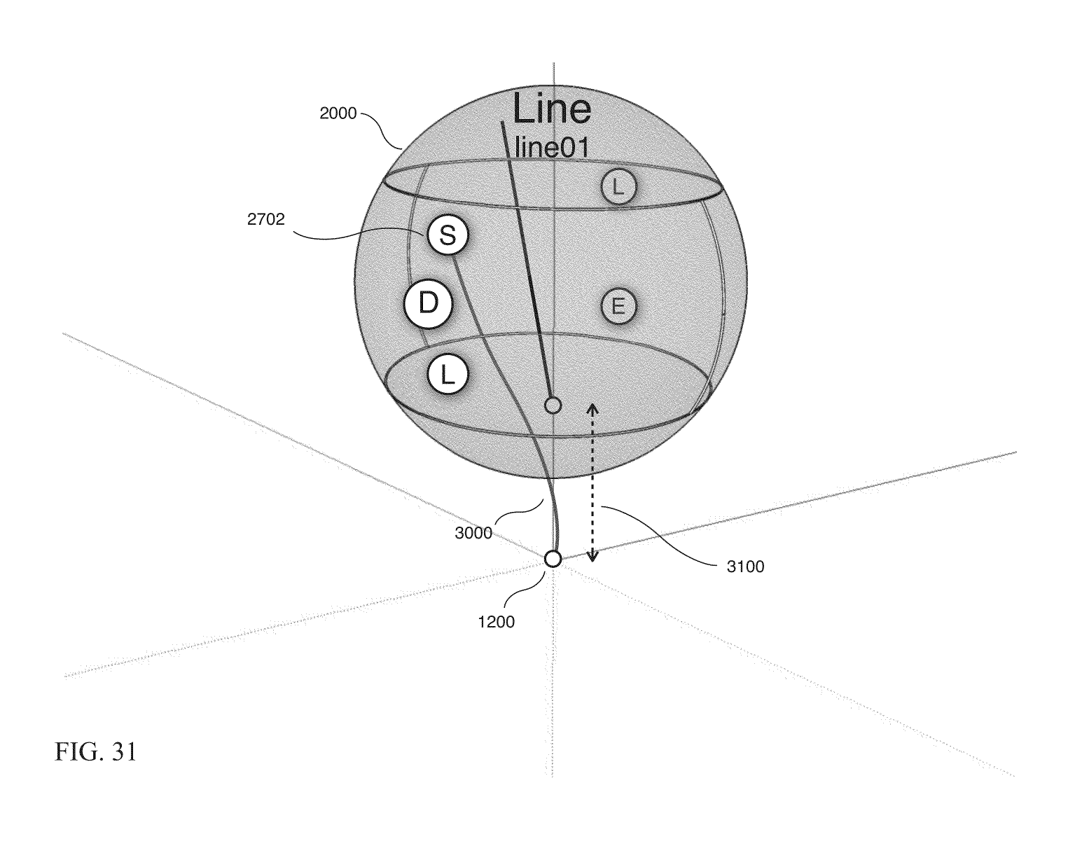

FIG. 31 illustrates the result of the updated graph 900 in the model 806. As the line object's interface 2000 is still exposed, an exploded view of the two objects is shown to the user to distinguish the two objects from one another. (A dashed arrow 3100 illustrates some fixed distance the two objects are translated away from each other, but is not rendered onscreen). As the line object's interface 2000 is still exposed to the user, the parametric link 3000 is rendered onscreen. The line object's start point parameter 2702 is the receiver of the parametric link coming from the point object 1200. The location of the point object 1200 now determines the start point of the line object. The rendered geometry is updated onscreen in the viewport as depicted in FIG. 31.

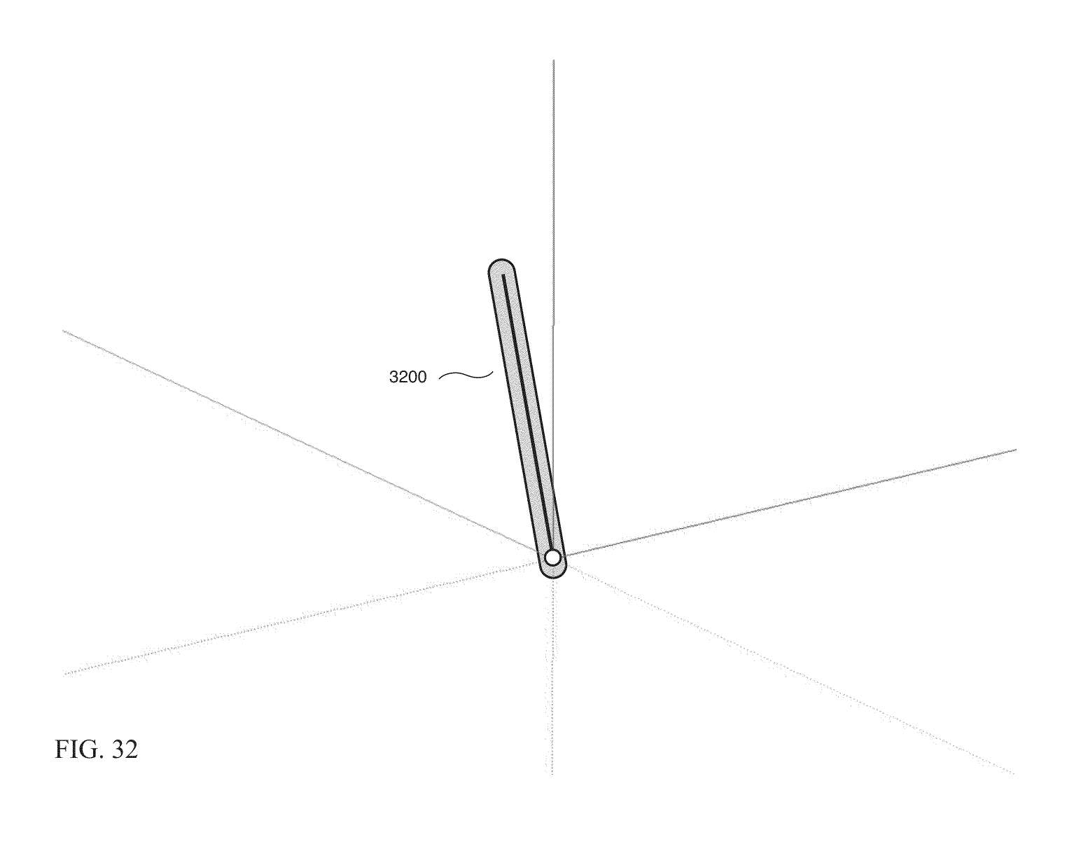

FIG. 32 illustrates the rendered result of hiding the line object's interface. The graph 900 representing the model 806 is updated and rendered to screen. The user now views the result of a single parametric link between the point object and the line object. The line object, now updated, remains selected 3200.

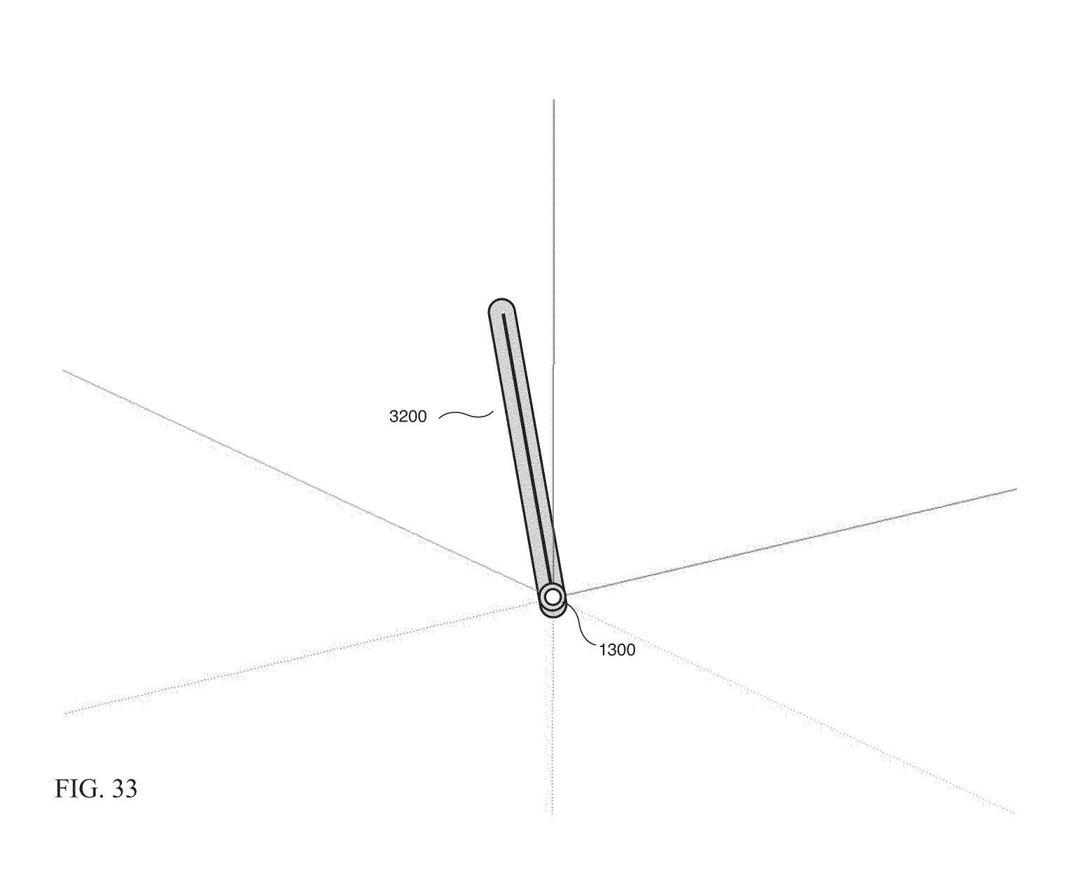

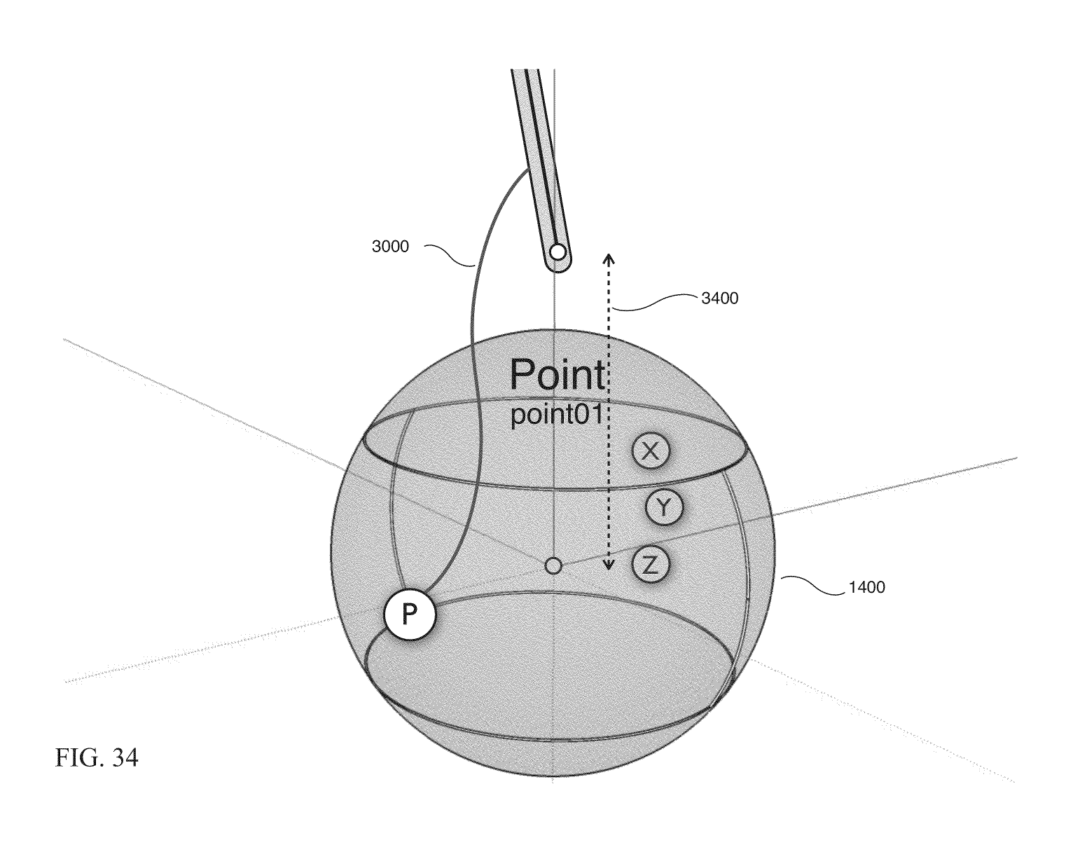

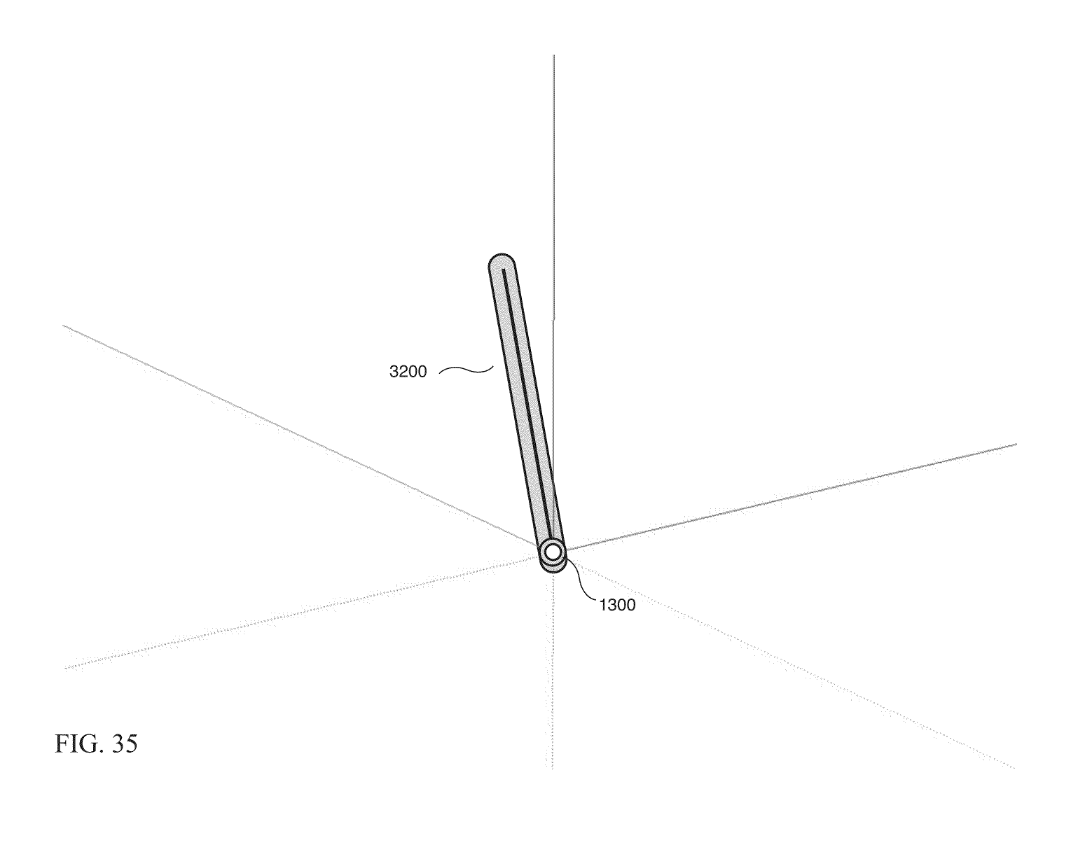

FIG. 33 illustrates that there remains two distinct objects: a selected point object 1300 and a selected line object 3200. FIG. 34 shows the result of exposing the bounding volume 1400 of the point object. In a similar fashion to FIG. 31, the point and line objects are translated 3400 away from each other to illustrate the distinction between the two objects as well as the parametric link 3000 between them. (A dashed arrow 3400 is for illustration purposes and is not rendered onscreen). FIG. 35 illustrates the result of the user hiding all object interfaces.

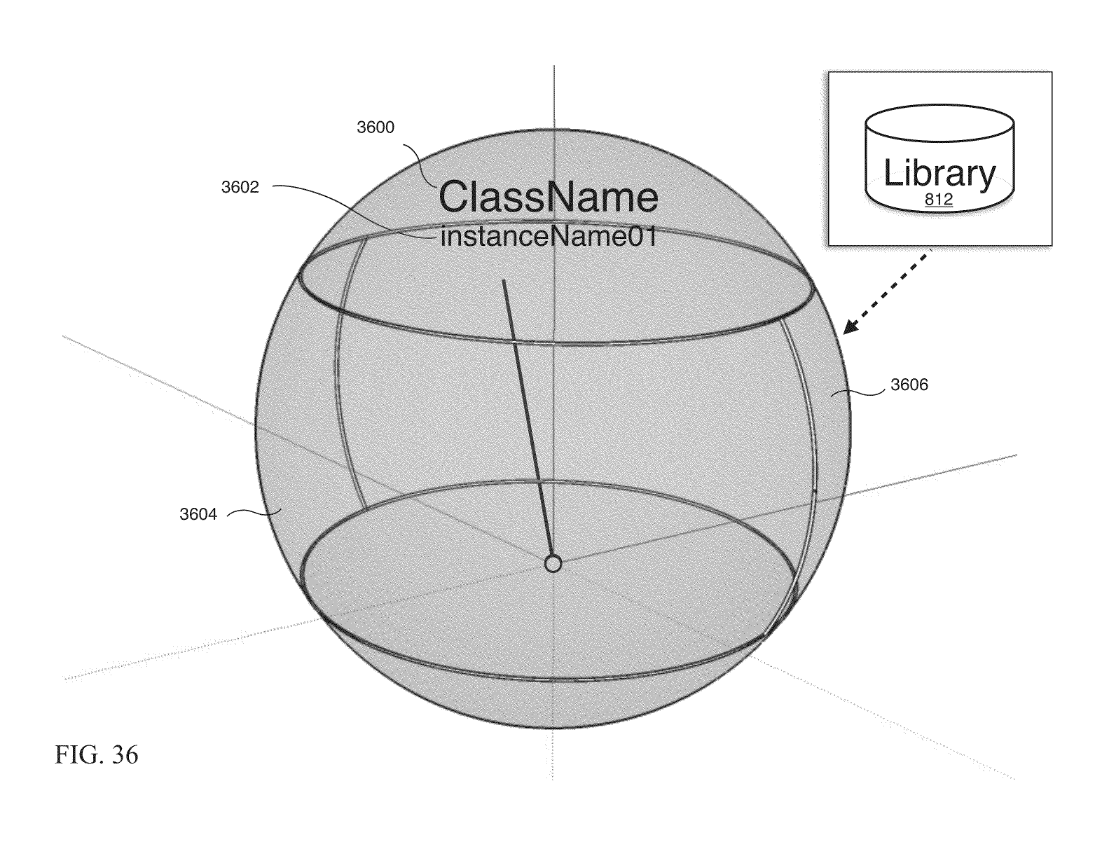

At this point, the user may wish to combine the point and line into one unified object. To do this, the user may create a new object. FIG. 36 illustrates the user adding an empty class 3600 instance 3602 around the line and point objects. The new class template is added from the library 812. Notice that the new class instance 3602 does not expose any parameters on its bounding volume and the input zone 3604 and output zone 3606 are empty. The user may add the empty class object by grouping two selected objects using a command from the keyboard, a gesture on a touch screen, a vocalized command, clicking and dragging with a mouse and a cursor, or similar methods. This new instance groups the two objects together into one compound object. The user may now enter into the object's implementation to customize the behavior and properties of the object.

FIG. 37 illustrates the result of the user entering into the bounding volume and thus the implementation of the instance. An interior 3700 Cartesian space contains the child objects and the parameters of the object. Once the user is within the implementation of the instance, the bounding volume is rendered as a two-dimensional boundary shape 3701 around the object. The user may adjust the perspective and move around with the interior space 3700 of the instance in the same fashion that the user adjusts their perspective with the root Cartesian space. The implementation boundary shape 3701 may be divided into zones for identity 3702, input parameters 3704, and output parameters 3706. These zones may be demarcated and rendered explicitly to the screen with lines 3708, 3710, 3712, 3714 that correspond to the lines 710 demarcating the external interface zones 712, 714, 716.

FIG. 38 illustrates that the behavior of child objects within the parent object's instance implementation behave much like they do outside the parent object's bounding volume. The user may expose the bounding volume of the point object 1400, in a similar fashion to that depicted in FIG. 34. The child objects are translated/exploded away from each other showing their parametric relationship(s).

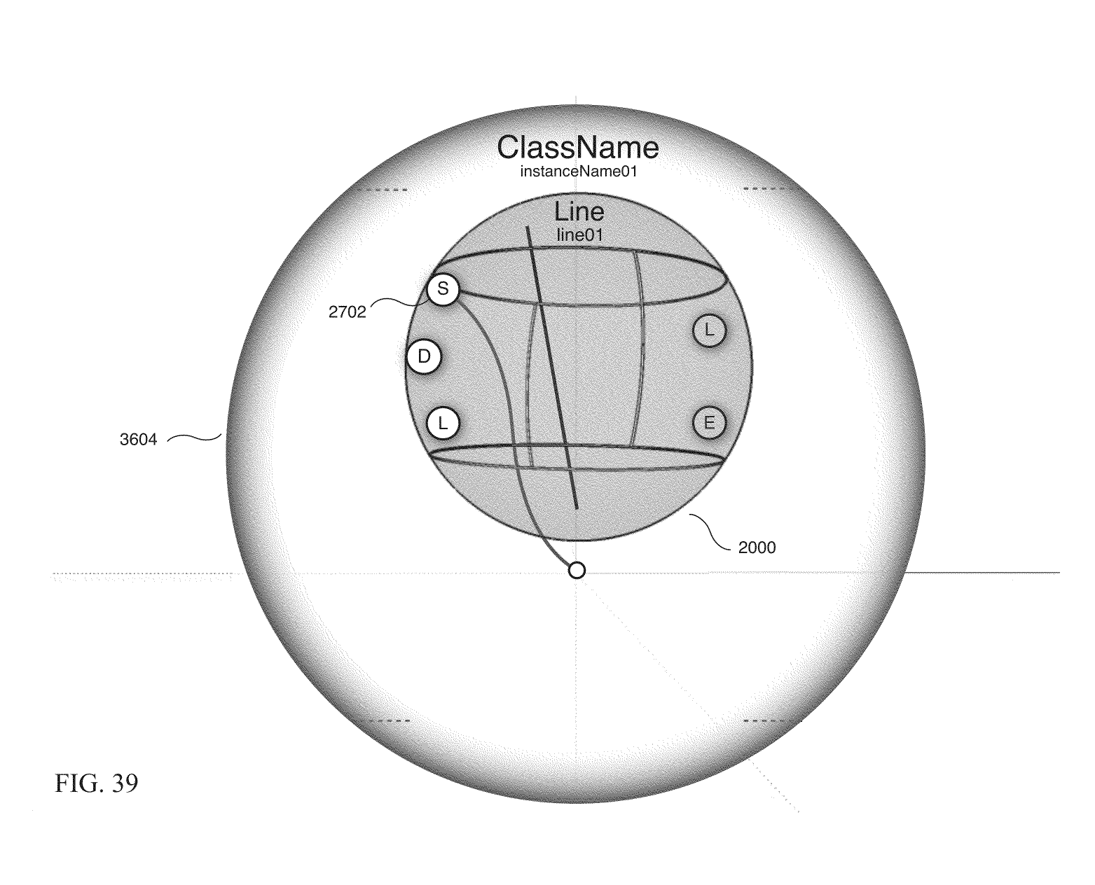

FIG. 39 illustrates the result of hiding the point instance's interface and exposing the line instance's interface 2000. The user now wishes to expose the line object's start point parameter 2702 as an external parameter of the parent object's input zone 3604.

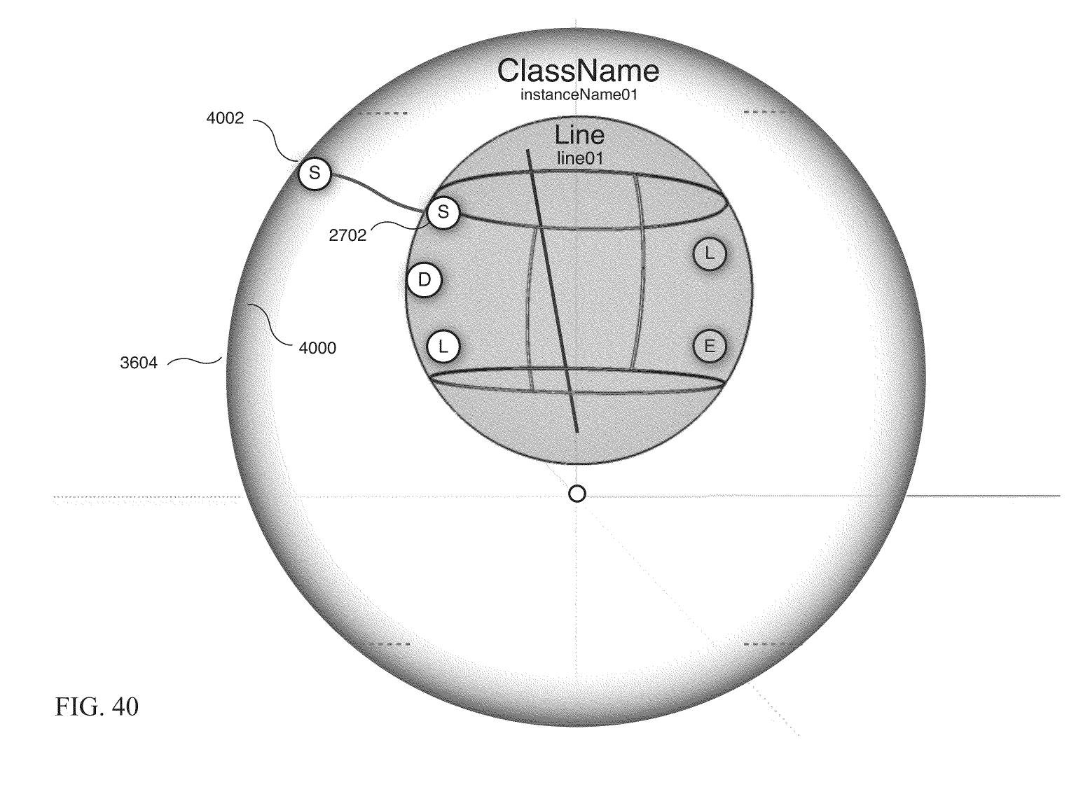

FIG. 40 illustrates the result of adding the start point parameter 2702 as an external parameter of the parent class. The user may add this parameter by creating a link between the line's start point parameter 2702 and the previously empty input zone 3604 of the parent object. This is done in a similar fashion to that illustrated in FIG. 28. As the user drags the link from the start point parameter 2702 and enters the input zone 4000, a new parameter 4002 with the same properties as the start point 2702 is added to the object's interface.

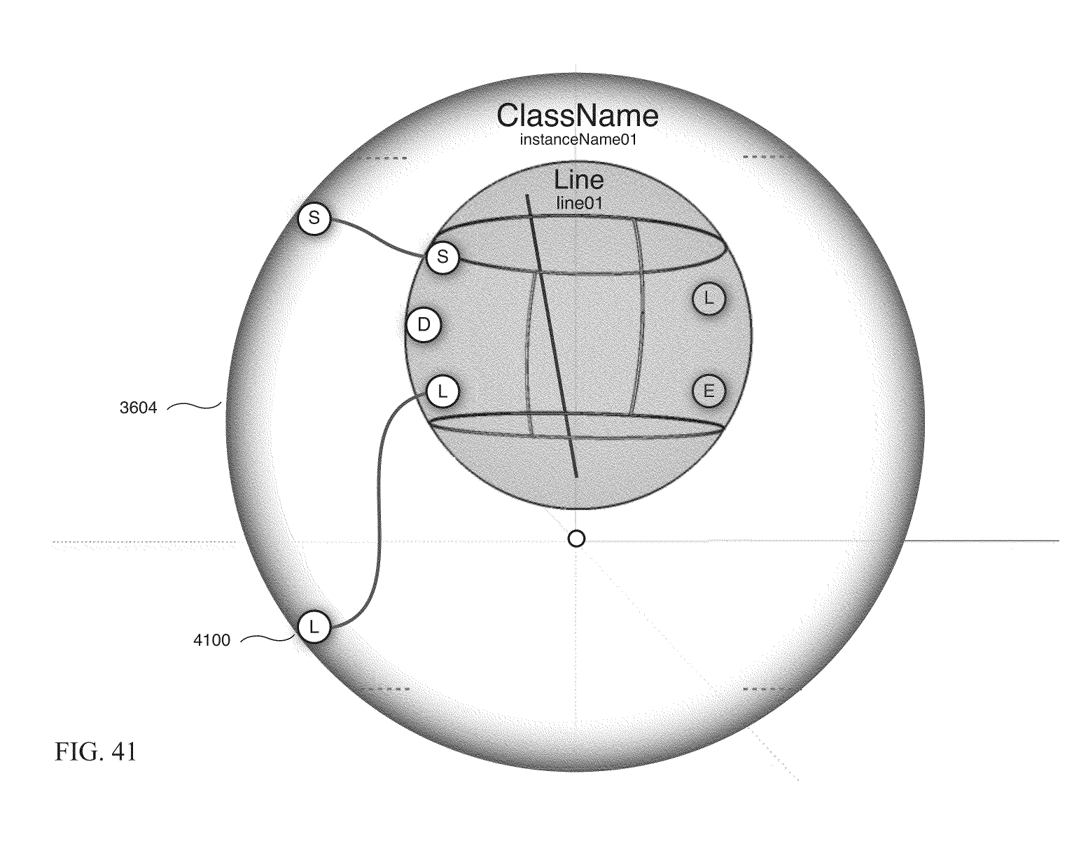

FIG. 41 illustrates the result of adding a length input parameter 4100 in a similar fashion to that depicted in FIG. 40.

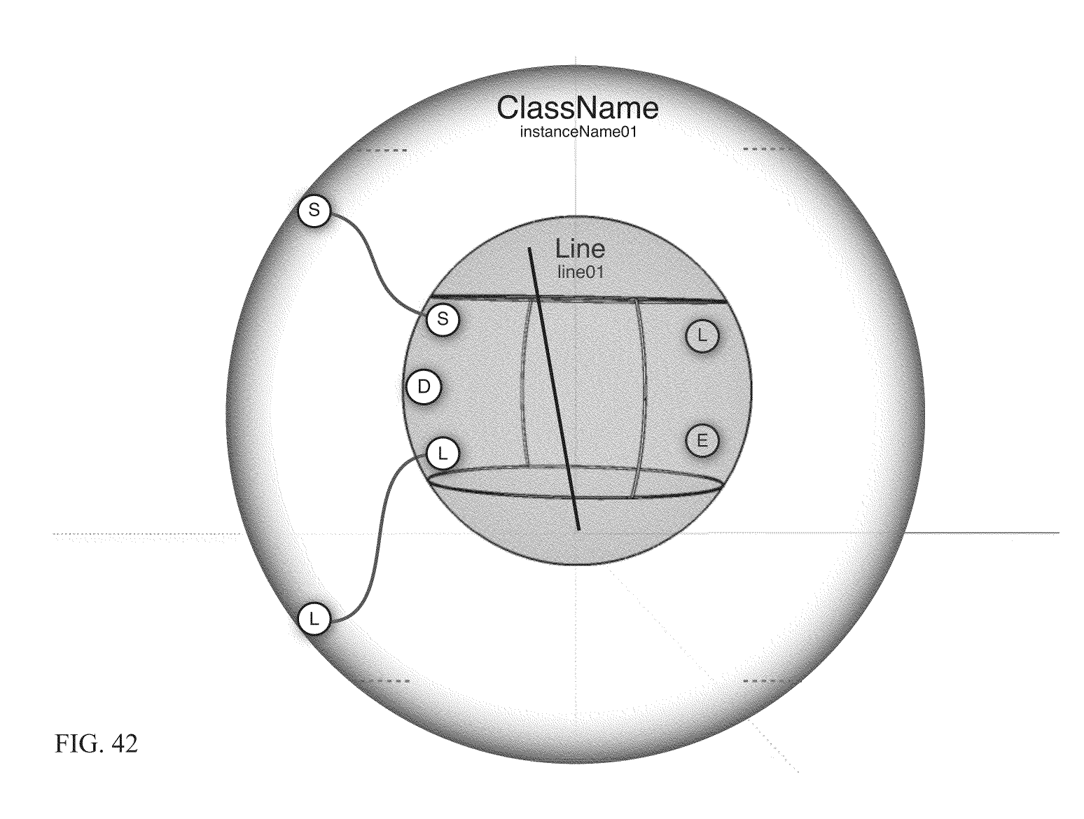

The user may wish this new object to accept parametric input that controls the start point and the length, but not the direction of the line. The point object contained in the class implementation was no longer needed, so it may be deleted by the user. FIG. 42 shows the result of deleting the point object. Object instances may be removed from the model by any number of methods including, but not limited to, mouse clicks, gesture input, keyboard commands, or similar methods.

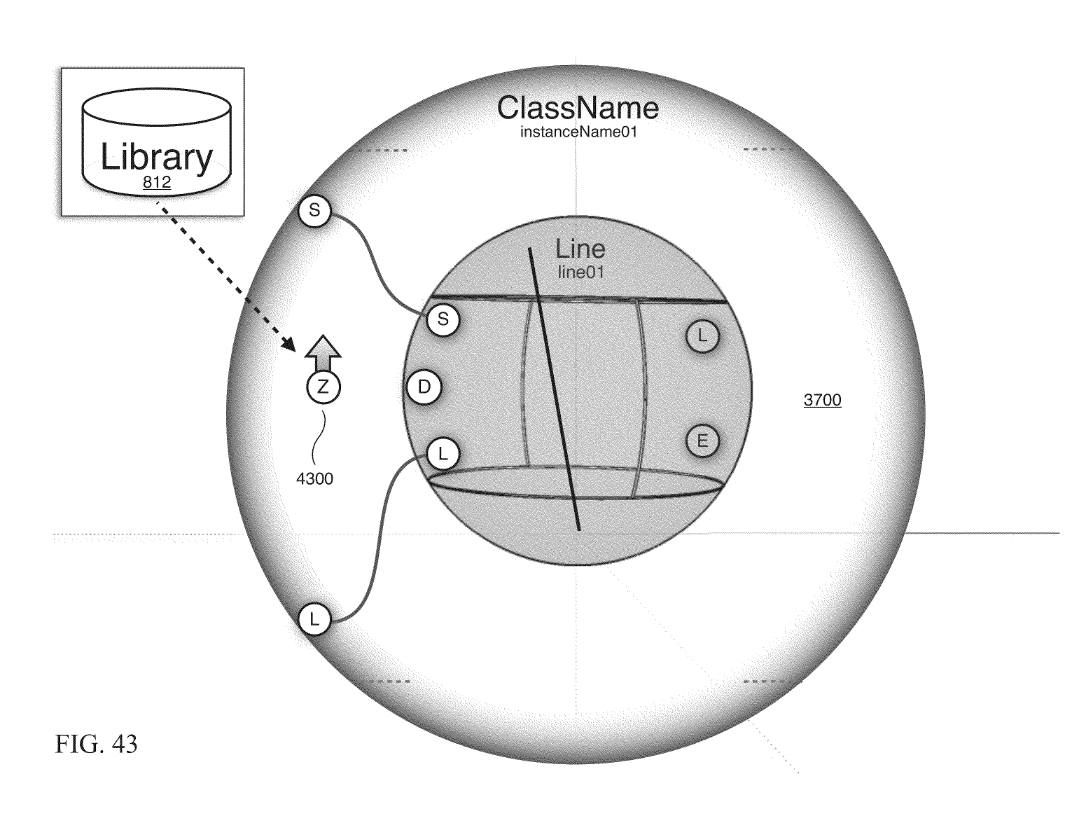

As stated above, the user wishes to restrict the object to lines that point upward in the Z axis. FIG. 43 shows the result of adding a z unit vector instance 4300 from the library 812 to the implementation 3700 of the parent object.

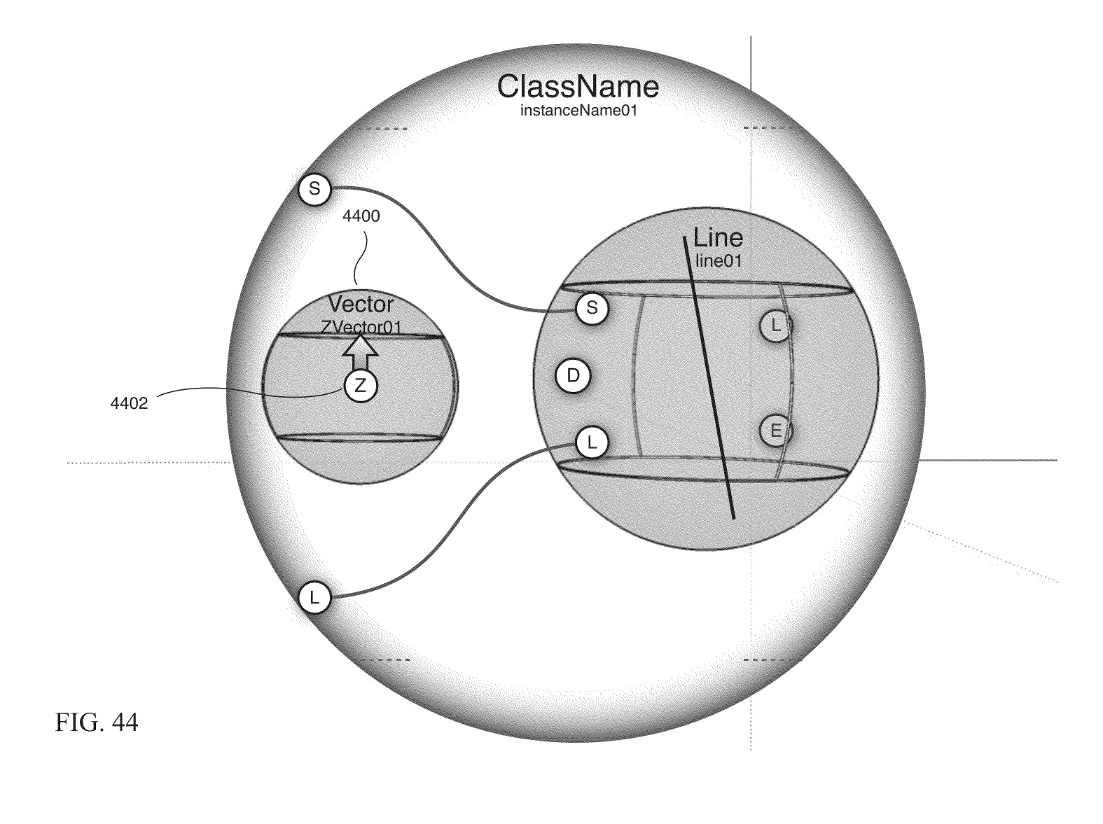

FIG. 44 illustrates the result of exposing the interface 4400 of the z unit vector. The z unit vector exposes one single output parameter 4402 that returns itself.

FIG. 45 illustrates the result of connecting the z unit vector output parameter 4402 to the direction input parameter 2200. The direction parameter accepts inputs of type vector as illustrated in FIG. 22. The graph 900 in the model 806 updates and the scene is rendered, constraining the line instance 1800.

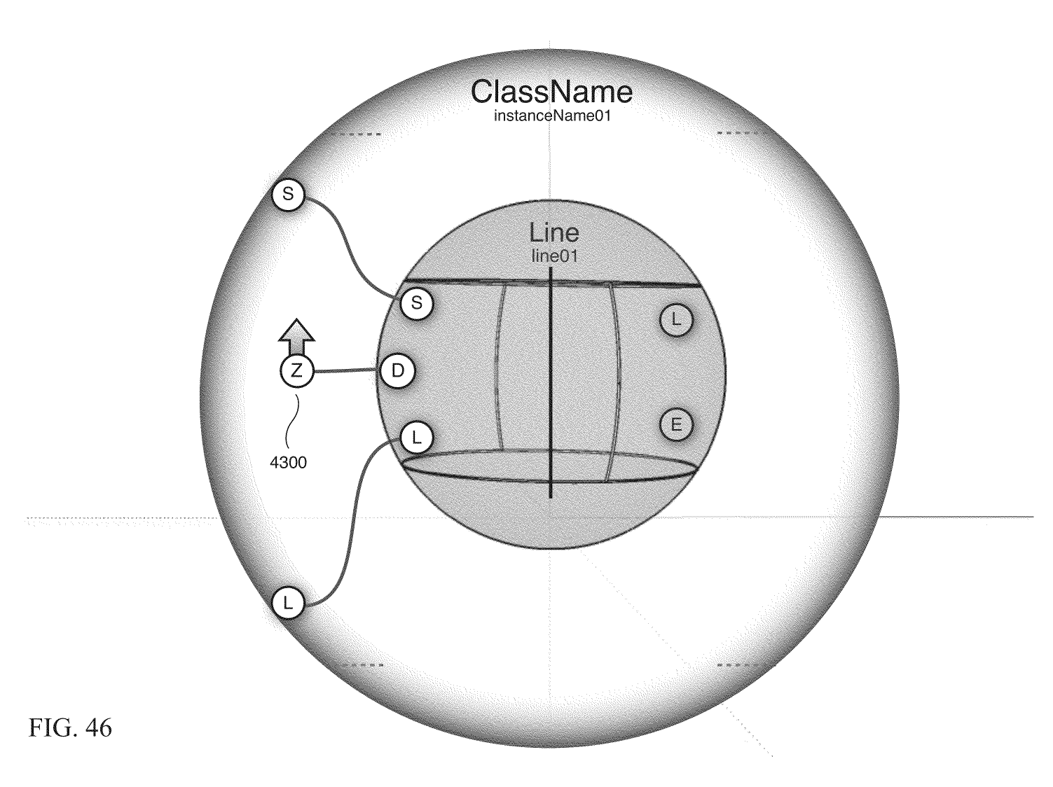

FIG. 46 illustrates the result of the user hiding the z unit vector 4300 interface.

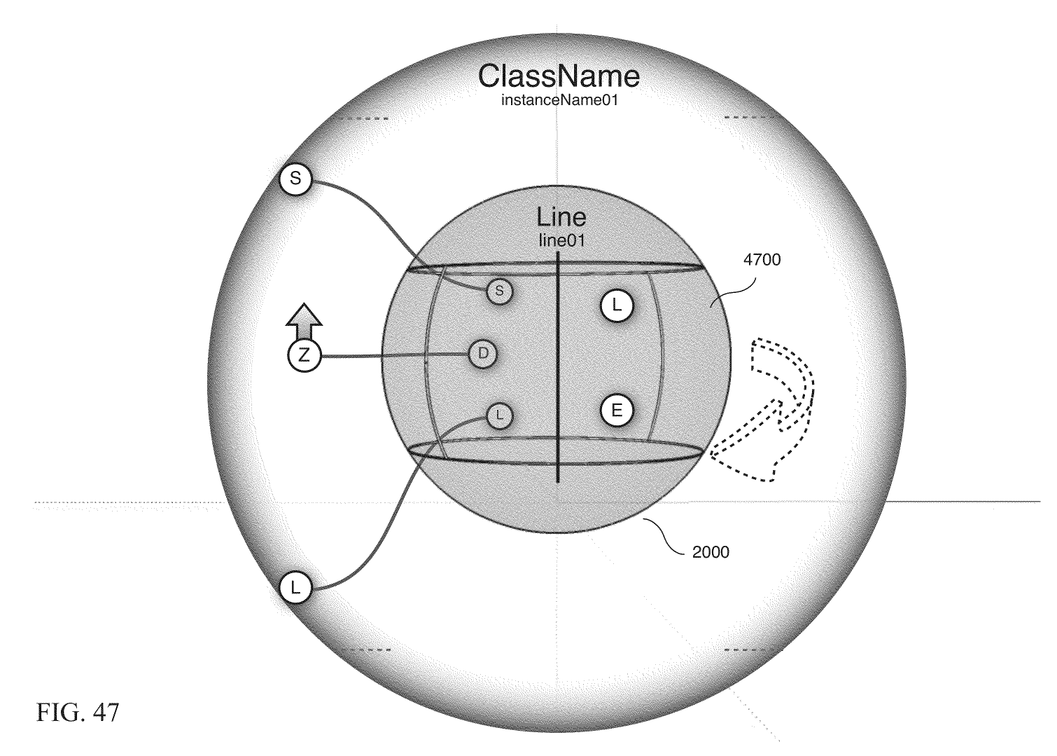

The user now wishes to expose the end point of the line on the interface of the parent object. FIG. 47 illustrates how the user may rotate the line interface 2000 so that the output zone 4700 is facing the viewing perspective.

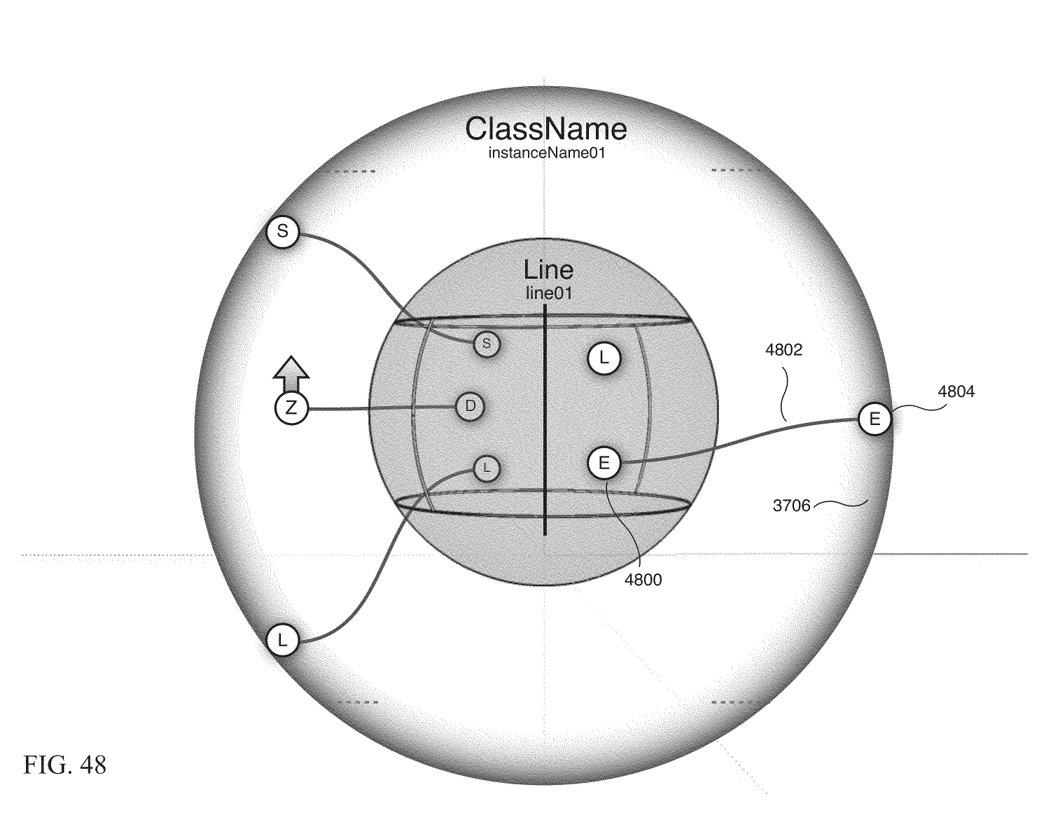

FIG. 48 illustrates the result of adding the line instance's endpoint parameter 4800 to the output zone 3706 of the parent object, in an analogous fashion to that illustrated in FIG. 40 and FIG. 41. This establishes a parametric link 4802 between the internal line instance's endpoint parameter 4800 and a new endpoint parameter 4804 exposed on the parent object's interface.

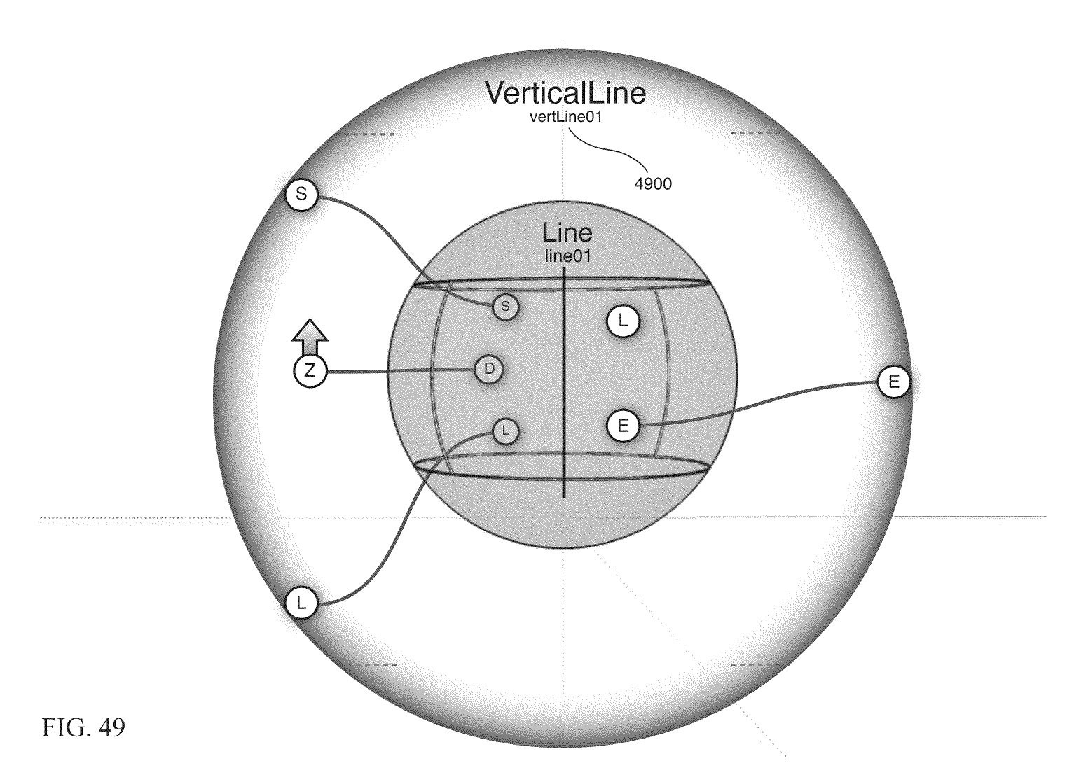

FIG. 49 illustrates the result of the user renaming the class and instance names 3600, 3602 with more appropriate names 4900.

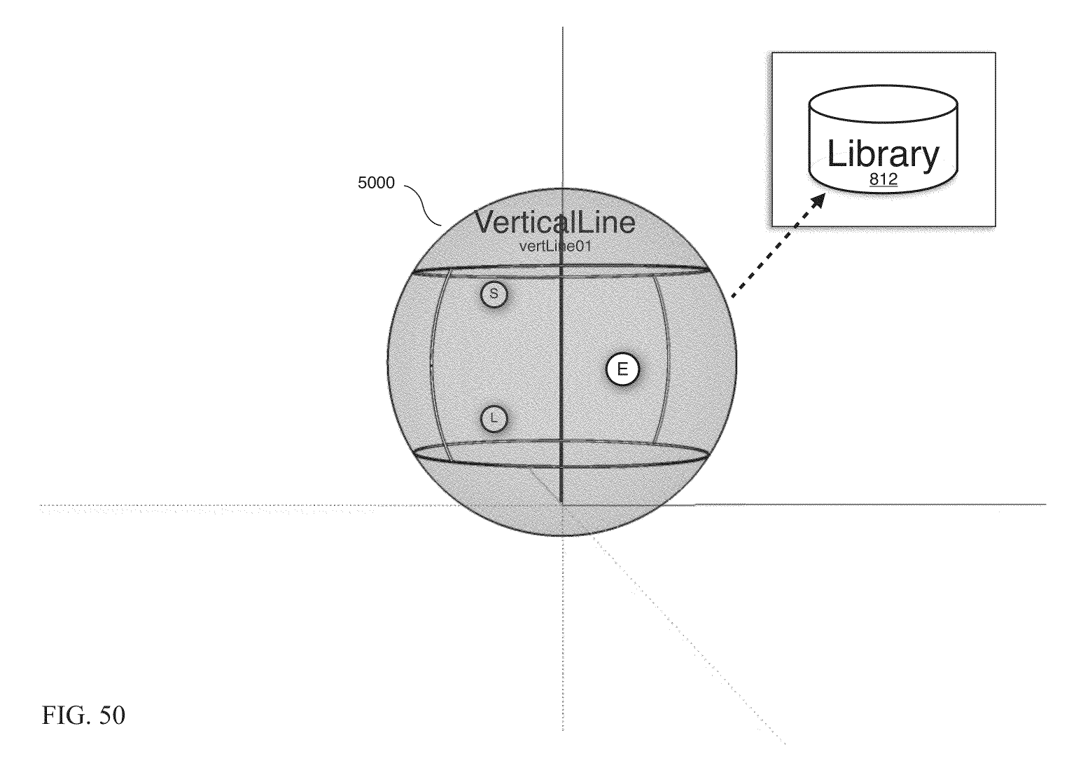

The user may close the implementation of the object by any number of methods including, but not limited to, keyboard commands, mouse-clicks or finger taps outside the bounding shape 3701 of the object. FIG. 50 illustrates the result of the user closing the implementation 3700 of a newly configured VerticalLine object instance verticalLine01 5000. The user may now add the newly configured object 5000 to the library 812 for reuse later as a template class.

While the technology has been described in connection with what is presently considered to be a practical embodiment, it is to be understood that the system, method, and user interface are not limited to the disclosed embodiment, but on the contrary, are intended to cover various modifications and equivalent arrangements included within the spirit and scope of the description. The method, system and user interface are capable of other and different embodiments, and its several details are capable of modifications in various obvious respects, all without departing from the system, method, and user interface. Accordingly, the drawings, description and operation are to be regarded as illustrative in nature, and not as restrictive.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a computing device, comprising:
rendering on a display a bounding volume representing a class, and rendering on the bounding volume a class name corresponding to the class;
rendering parameters of the object on the surface of the rendered bounding volume;
receiving, via a first user gesture made relative to the rendered object and parameters, an indication to connect a first data link to a first parameter;
receiving a first value for the connected first parameter; and
using the received first value as a value for first parameter of the class represented by the bounding volume.

2. The method of claim 1, further comprising:
receiving via a second user gesture made relative to the rendered object and parameters, an indication to connect a second data link to a second parameter;
receiving a second value for the connected second parameter; and
using the received second value as a value for second parameter of the class represented by the bounding volume.

3. The method of claim 1, further comprising transforming the rendering of the bounding volume according to the received first value.

4. The method of claim 1, further comprising compositing the rendering of the bounding volume with at least one real-world object to form an Augmented Reality user interface.

5. The method of claim 1, further comprising generating a graph for at least one bounding volume and associating logic with the at least one bounding volume based on the generated graph.

6. A system, comprising:
a processor and one or more memories;
one or more controls that each is an instance of a view that responds to user input;
a rendering engine configured to render and update object geometry and object bounding volumes;
a user interface controller configured to render objects as bounding volumes and receive user input relative to the rendered object; and
a component to topologically order a graph to generate a sorted graph, wherein invoking an update method on the sorted graph causes an update method to be invoked on each node of the graph, thereby validating the objects and causing the objects to be rendered by the rendering engine.

7. The system of claim 6, wherein the bounding volume constitutes a user interface for its corresponding object.

8. The system of claim 6, wherein data sent between objects are rendered as links drawn between parameters on a surface of the bounding volume.

9. The system of claim 6, wherein a new parametric object is created by linking and nesting objects into bounding volume clusters.

10. A computer-readable storage medium storing computer-executable instructions, comprising:
instructions for rendering on a display a bounding volume representing a class, and rendering on the bounding volume a class name corresponding to the class;
instructions for rendering parameters of the object on the surface of the rendered bounding volume;
instructions for receiving, via a first user gesture made relative to the rendered object and parameters, an indication to connect a first data link to a first parameter;
instructions for receiving a first value for the connected first parameter; and
instructions for using the received first value as a value for first parameter of the class represented by the bounding volume.
